(19) United States
(12) Patent Application Publication
(10) Pub. No.: US 2016/0381553 A1
(43) Pub. Date: Dec. 29, 2016

(54) ELECTRONIC DEVICE AND ELECTRONIC DEVICE SYSTEM

(71) Applicant: LG ELECTRONICS INC., Seoul (KR)

(72) Inventors: Hyundeok LEE, Seoul (KR); Eungsuk SHON, Seoul (KR); Sibong ROH, Seoul (KR)

(73) Assignee: LG ELECTRONICS INC., Seoul (KR)

(21) Appl. No.: 15/038,965

(22) PCT Filed: Feb. 6, 2014
(86) PCT No.: PCT/KR2014/001015

§ 371 Date: May 24, 2016

(30) Foreign Application Priority Data
Dec. 5, 2013 (KR) 10-2013-0150908

(51) Int. Cl. H04W 12/06; H04W 76/02

(52) U.S. Cl. CPC H04W 12/06; H04W 76/023; H04W 4/008

(57) ABSTRACT

The present invention proposes an electronic device and an electronic device system in which electronic devices operate interconnectedly. An electronic device proposed in the present invention comprises a wired/wireless communication unit, and a control unit configured to perform a function of being interconnected to another electronic device in combination with the wired/wireless communication unit, wherein the wired/wireless communication unit and the control unit perform the steps of: being wired/wirelessly connected to the another electronic device and performing reciprocal authentication in order to complete an authentication with the another electronic device prior to performing the function of being interconnected to the another electronic device; determining an application that is executable in interconnection with the another electronic device via the wired/wireless connection on the basis of a preset criterion; and sending a signal generated in the determined application to the another electronic device in order that on executing the determined application, it is also possible to enable an application corresponding to the determined application to be executed on the another electronic device and to operate interconnectedly.

### TECHNICAL FIELD

The present invention relates to an electronic device interworked with another electronic device through applications executable by interworking, and an electronic device system where a plurality of electronic devices are interworked with each other.

### BACKGROUND ART

Wireless communication electronic devices used in a daily life include mobile terminals including portable phones or tablets. As technology develops and application fields become various, the conventional electronic device is also provided with a wireless communication module, so as to be used as a wireless communication electronic device.

For instance, a smart television configured as the conventional television which transmits broadcasting by merely receiving an electric wave of a broadcasting station is provided with a wireless communication module, serves not only a television which transmits broadcasting, but also an electronic device which can use Internet according to a user's selection. Such a tendency is being widely applied to not only a television, but also a refrigerator, a washing machine, a cleaner, etc. which can be controlled remotely. Such a wireless communication electronic device can communicate with at least one other electronic device through short-range wireless communication.

As an application field of wireless communication electronic devices is extended, developing the wireless communication electronic devices by software and hardware may be considered. As one of the developments, an electronic device using an application executable by interworking with another electronic device based on an authenticated wireless connection, and an electronic device system may be considered.

### DISCLOSURE OF THE INVENTION

Therefore, an object of the present invention is to provide an electronic device capable of executing a corresponding application in another electronic device based on an authenticated connection when an application executable by interworking is installed at wireless communication electronic devices which belong to the same network, and an electronic device system.

Another object of the present invention is to provide an electronic device capable of recommending an application executable by interworking with another electronic device, based on an authenticated connection, based on a preset criterion when the application is not installed at said another electronic device, and an electronic device system.

Another object of the present invention is to provide an electronic device system which has a plurality of electronic devices interworked with each other, by extending an interworking operation based on a reciprocally authenticated connection to various wireless communication electronic devices.

To achieve these and other advantages and in accordance with the purpose of the present invention, as embodied and broadly described herein, there is provided an electronic device, including: a wired/wireless communication unit; and a controller configured to execute an interworking function with another electronic device by cooperating with the wired/wireless communication unit, wherein the wired/wireless communication unit and the controller perform the steps of: authenticating with said another electronic device by being connected to said another electronic device by wire or wirelessly, such that the authentication with said another electronic device is completed, before the interworking function with said another electronic device is executed; determining, based on a preset criterion, an application executable by interworking with said another electronic device through wired/wireless connection; and transmitting, to said another electronic device, a signal generated from the determined application such that an application corresponding to the determined application is executed in said another electronic device when the determined application is executed, for interworking.

In an embodiment of the present invention, the signal generated from the determined application may include an execution command with respect to the corresponding application, such that the corresponding application may be executed in said another electronic device.

In another embodiment of the present invention, if the corresponding application has not been installed in said another electronic device, the wired/wireless communication unit and the controller may transmit, to said another electronic device, recommendation information with respect to the corresponding application, such that the corresponding application may be installed at said another electronic device.

The recommendation information with respect to the corresponding application may include an on-line address of an external server, such that said another electronic device may download the corresponding application from the external server, based on the recommendation information.

In another embodiment of the present invention, the determined application and the corresponding application may be determined based on at least one of a type and the number of the electronic device, a communication method with said another electronic device, a hardware and a software supported by said another electronic device, and a reciprocal authentication level with said another electronic device.

In another embodiment of the present invention, said another electronic device may include a plurality of other electronic devices. If other electronic devices rather than said already-authenticated another electronic device are additionally authenticated, the wired/wireless communication unit and the controller may perform the steps of: newly determining, based on a preset criterion, an application executable by interworking with at least part of the plurality of other electronic devices; and transmitting a signal related to the newly-determined application to at least one of the plurality of other electronic devices when the newly-determined application is executed.

The wired/wireless communication unit and the controller may transmit a signal generated from an application executable by interworking with one of the plurality of electronic devices, to another of them, for interworking among said other electronic devices.

In another embodiment of the present invention, said other electronic devices may include a first electronic device and a second electronic device connected to the electronic device by wire or wirelessly, through a first network and a second network, respectively. The wired/wireless communication unit and the controller may transmit, to the second electronic device through the second network, a signal received from the first electronic device through the first network, such that the first and second another electronic devices may be interworked with each other.

According to another embodiment of the present invention, there is provided an electronic device, including: a wired/wireless communication unit configured to execute wired/wireless communication with another electronic device; and a controller configured to complete authentication with said another electronic device before an interworking function with said another electronic device is executed, and configured to execute an application corresponding to an application of said another electronic device when the wired/wireless communication unit receives an application-related signal from said another electronic device, for interworking with said another electronic device.

In another embodiment of the present invention, if the corresponding application has not been installed, the controller may control the wired/wireless communication unit to download the corresponding application from an external server, based on recommendation information provided from said another electronic device.

To achieve these and other advantages and in accordance with the purpose of the present invention, as embodied and broadly described herein, there is also provided an electronic device system having first and second electronic devices connected to each other by wire or wirelessly, wherein the first electronic device includes a wired/wireless communication unit, and a controller configured to execute an interworking function with another electronic device by cooperating with the wired/wireless communication unit, wherein the wired/wireless communication and the controller perform the steps of: authenticating with the second electronic device by being connected to the second electronic device by wire or wirelessly, such that the authentication with the second electronic device is completed before an interworking function with the second electronic device is executed; determining, based on a preset criterion, an application executable by interworking with the second electronic device through wired/wireless connection; and transmitting, to the second electronic device, a signal generated from the determined application such that an application corresponding to the determined application is executed in the second electronic device when the determined application is executed, for interworking, and wherein if information about the determined application is transmitted to the second electronic device from the first electronic device, the second electronic device executes an application corresponding to the determined application such that an operation interworked with the first electronic device may be executable.

In an embodiment of the present invention, if the corresponding application has not been installed in the second electronic device, the wired/wireless communication unit and the controller of the first electronic device may transmit, to the second electronic device, recommendation information with respect to the corresponding application, such that the corresponding application may be installed at the second electronic device.

The recommendation information with respect to the corresponding application may include an on-line address of an external server, such that the second electronic device may download the corresponding application from the external server, based on the recommendation information.

In an embodiment of the present invention, the determined application and the corresponding application may be determined based on at least one of a type and the number of the first and second electronic devices, a communication method between the first and second electronic devices, a hardware and a software supported by the first and second electronic devices, and a reciprocal authentication level between the first and second electronic devices.

In an embodiment of the present invention, further including a third electronic device connected to the first electronic device by wire or wirelessly. The wired/wireless communication unit and the controller may perform the steps of: authenticating with the third electronic device by being connected to the third electronic device by wire or wirelessly, such that the authentication with the third electronic device is completed before an interworking function with the third electronic device is executed; determining, based on a preset criterion, an application executable by interworking with the third electronic device through wired/wireless connection; transmitting, to the third electronic device, a signal generated from the determined application such that an application corresponding to the determined application is executed in the third electronic device when the determined application is executed, for interworking; and transmitting a signal generated from an application executable by interworking with one of the second and third electronic devices, to another of them, for interworking between the second and third electronic devices.

### Advantageous Effects

Firstly, the electronic device determines an application executable by interworking based on a preset criterion, after completing authentication with another electronic device. Then, the electronic device transmits a signal related to the determined application to said another electronic device when executing the determined application. Accordingly, said another electronic device may execute an application corresponding to the transmitted signal, without an additional authentication process, based on an authenticated connection. This may allow users of different electronic devices to use applications interworked with each other, without an additional authentication process.

Further, even when an application executable by interworking is not installed at another electronic device, the electronic device transmits information about an application determined based on a preset criterion, to said another electronic device. Thus, the electronic device may propose the application executable by interworking to said anther electronic device. Accordingly, not applications selected by a user arbitrarily, but optimum applications usable by the electronic devices authenticated with each other may be recommend to be executable.

Further, the present invention provides a base operable by interworking with all types of wireless communication electronic devices, and provides an electronic device system including a plurality of electronic devices and having a structure where different types of electronic devices are interworked with each other through a single electronic device.

### BRIEF DESCRIPTION OF THE DRAWINGS

FIG. 1 is a block diagram of an electronic device according to an embodiment of the present invention;

FIGS. 2A and 2B are conceptual views of a communication system where an electronic device of the present invention is operable;

FIG. 3A is a front perspective view of an electronic device according to the present invention;

FIG. 3B is a rear perspective view of the electronic device shown in FIG. 3A;

FIG. 4 is a conceptual view illustrating a connection relation between an electronic device an embodiment with another electronic device according to an embodiment of the present invention;

FIG. 5 is a flowchart illustrating that an electronic device of the present invention is operated by interworking with another electronic device, based on the connection relation between the electronic devices shown in FIG. 4;

FIGS. 6A and 6B are conceptual views illustrating a process of transmitting an execution command of an application executable by interworking, to another electronic device, based on an authenticated connection, according to an embodiment of the present invention;

FIGS. 7A and 7B are conceptual views illustrating a process of transmitting recommendation information with respect to an application executable by interworking, to another electronic device, according to an embodiment of the present invention;

FIG. 8 is a conceptual view illustrating a connection relation between an electronic device and another electronic device according to another embodiment of the present invention;

FIG. 9 is a flowchart illustrating that an electronic device of the present invention is operated by interworking with a plurality of other electronic devices, based on the connection relation among the electronic devices shown in FIG. 8;

FIG. 10 is a conceptual view illustrating a connection relation and interworking among a plurality of electronic devices interconnected to each other through different networks;

FIG. 11 is a flowchart illustrating that an electronic device of the present invention is operated by interworking with a plurality of other electronic devices, based on the connection relation among the electronic devices shown in FIG. 10;

FIGS. 12A and 12B are conceptual views illustrating that a plurality of electronic devices are operated by interworking based on an authenticated connection;

FIGS. 13A and 13B are conceptual views illustrating that a new authentication connection electronic device is added to the conventional authentication connection electronic devices; and

FIGS. 14 and 15 are conceptual views illustrating a plurality of electronic devices which consist of an electronic device system are operated by interworking.

### MODES FOR CARRYING OUT THE PREFERRED EMBODIMENTS

Description will now be given in detail according to the exemplary embodiments, with reference to the accompanying drawings. For the sake of brief description with reference to the drawings, the same or equivalent components will be provided with the same reference numbers, and description thereof will not be repeated. A suffix “module” or “unit” used for constituent elements disclosed in the following description is merely intended for easy description of the specification, and the suffix itself does not give any special meaning or function. In describing the present invention, if a detailed explanation for a related known function or construction is considered to unnecessarily divert the gist of the present disclosure, such explanation has been omitted but would be understood by those skilled in the art. The accompanying drawings are used to help easily understood the technical idea of the present invention and it should be understood that the idea of the present disclosure is not limited by the accompanying drawings.

Electronic devices described herein may include not only electronic devices which are operated through wired/wires communication such as mobile terminals, but also devices which are operated through wired/wires communication by having an additional wired/wireless communication module therein. For instance, the electronic devices may include not only mobile terminals such as a portable phone or a smart phone, but also a refrigerator, a washing machine or a cleaner.

The mobile terminal, a type of the electronic device, may include cellular phones, smart phones, laptop computers, digital broadcasting terminals, personal digital assistants (PDAs), portable multimedia players (PMPs), navigators, slate PCs, tablet PC, ultra books and the like. However, it may be easily understood by those skilled in the art that the configuration according to the exemplary embodiments of this specification can be applied to stationary terminals such as digital TV, desktop computers and the like excluding a case of being applicable only to the mobile terminals.

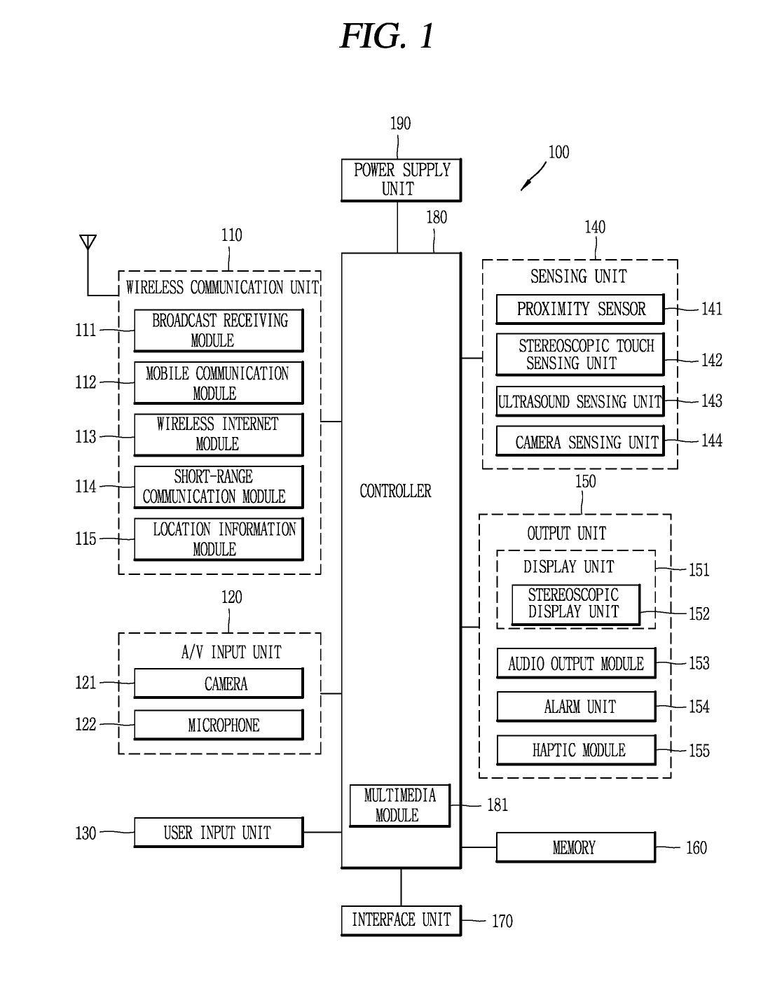

FIG. 1 is a block diagram of an electronic device 100 in accordance with one exemplary embodiment.

The electronic device 100 may comprise components, such as a wireless communication unit 110, an Audio/Video (AN) input unit 120, a user input unit 130, a sensing unit 140, an output unit 150, a memory 160, an interface unit 170, a controller 180, a power supply 190 and the like. FIG. 1 shows the electronic device 100 having various components, but it is understood that implementing all of the illustrated components is not a requirement. Greater or fewer components may alternatively be implemented.

Hereinafter, each component is described in sequence.

The wireless communication unit 110 may typically include one or more modules which permit wireless communications between the electronic device 100 and a wireless communication system or between the electronic device 100 and a network within which the electronic device 100 is located. For example, the wireless communication unit 110 may include at least one of a broadcast receiving module 111, a mobile communication module 112, a wireless Internet module 113, a short-range communication module 114, a location information module 115 and the like.

The broadcast receiving module 111 receives a broadcast signal and/or broadcast associated information from an external broadcast managing entity via a broadcast channel.

The broadcast channel may include a satellite channel and a terrestrial channel. The broadcast managing entity may indicate a server which generates and transmits a broadcast signal and/or broadcast associated information or a server which receives a pre-generated broadcast signal and/or broadcast associated information and sends them to the mobile terminal. The broadcast signal may be implemented as a TV broadcast signal, a radio broadcast signal, and a data broadcast signal, among others. The broadcast signal may further include a data broadcast signal combined with a TV or radio broadcast signal.

Examples of broadcast associated information may include information associated with a broadcast channel, a broadcast program, a broadcast service provider, and the like. The broadcast associated information may be provided via a mobile communication network, and received by the mobile communication module 112.

The broadcast associated information may be implemented in various formats. For instance, broadcast associated information may include Electronic Program Guide (EPG) of Digital Multimedia Broadcasting (DMB), Electronic Service Guide (ESG) of Digital Video Broadcast-Handheld (DVB-H), and the like.

The broadcast receiving module 111 may be configured to receive digital broadcast signals transmitted from various types of broadcast systems. Such broadcast systems may include Digital Multimedia Broadcasting-Terrestrial (DMB-T), Digital Multimedia Broadcasting-Satellite (DMB-S), Media Forward Link Only (MediaFLO), Digital Video Broadcast-Handheld (DVB-H), Integrated Services Digital Broadcast-Terrestrial (ISDB-T) and the like. The broadcast receiving module 111 may be configured to be suitable for every broadcast system transmitting broadcast signals as well as the digital broadcasting systems.

Broadcast signals and/or broadcast associated information received via the broadcast receiving module 111 may be stored in a suitable device, such as a memory 160.

The mobile communication module 112 transmits/receives wireless signals to/from at least one of network entities (e.g., base station, an external mobile terminal, a server, etc.) on a mobile communication network. Here, the wireless signals may include audio call signal, video (telephony) call signal, or various formats of data according to transmission/reception of text/multimedia messages.

The mobile communication module 112 may implement a video call mode and a voice call mode. The video call mode indicates a state of calling with watching a callee's image. The voice call mode indicates a state of calling without watching the callee's image. The wireless communication module 112 may transmit and receive at least one of voice and image in order to implement the video call mode and the voice call mode.

The wireless Internet module 113 supports wireless Internet access for the mobile terminal. This module may be internally or externally coupled to the electronic device 100. Examples of such wireless Internet access may include Wireless LAN (WLAN) (Wi-Fi), Wireless Broadband (Wibro), Worldwide Interoperability for Microwave Access (Wimax), High Speed Downlink Packet Access (HSDPA) and the like.

The short-range communication module 114 denotes a module for short-range communications. Suitable technologies for implementing this module may include BLUETOOTH™, Radio Frequency IDentification (RFID), Infrared Data Association (IrDA), Ultra-WideBand (UWB), ZigBee™, Near Field Communication (NFC) and the like.

The location information module 115 denotes a module for detecting or calculating a position of a mobile terminal. An example of the location information module 115 may include a Global Position System (GPS) module.

Still referring to FIG. 1, the AN input unit 120 is configured to provide audio or video signal input to the mobile terminal. The AN input unit 120 may include a camera 121 and a microphone 122. The camera 121 receives and processes image frames of still pictures or video obtained by image sensors in a video call mode or a capturing mode. The processed image frames may be displayed on a display unit 151.

The image frames processed by the camera 121 may be stored in the memory 160 or transmitted to the exterior via the wireless communication unit 110. Also, user's position information and the like may be calculated from the image frames acquired by the camera 121. Two or more cameras 121 may be provided according to the configuration of the mobile terminal.

The microphone 122 may receive an external audio signal while the mobile terminal is in a particular mode, such as a phone call mode, a recording mode, a voice recognition mode, or the like. This audio signal is processed into digital data. The processed digital data is converted for output into a format transmittable to a mobile communication base station via the mobile communication module 112 in case of the phone call mode. The microphone 122 may include assorted noise removing algorithms to remove noise generated in the course of receiving the external audio signal.

The user input unit 130 may generate input data input by a user to control the operation of the mobile terminal. The user input unit 130 may include a keypad, a dome switch, a touchpad (e.g., static pressure/capacitance), a jog wheel, a jog switch and the like.

The sensing unit 140 provides status measurements of various aspects of the mobile terminal. For instance, the sensing unit 140 may detect an open/close status of the mobile terminal, a change in a location of the electronic device 100, a presence or absence of user contact with the electronic device 100, the location of the electronic device 100, acceleration/deceleration of the electronic device 100, and the like, so as to generate a sensing signal for controlling the operation of the electronic device 100. For example, regarding a slide-type mobile terminal, the sensing unit 140 may sense whether a sliding portion of the mobile terminal is open or closed. Other examples include sensing functions, such as the sensing unit 140 sensing the presence or absence of power provided by the power supply 190, the presence or absence of a coupling or other connection between the interface unit 170 and an external device.

The output unit 150 is configured to output an audio signal, a video signal or a tactile signal. The output unit 150 may include a display unit 151, an audio output module 153, an alarm unit 154 and a haptic module 155.

The display unit 151 may output information processed in the electronic device 100. For example, when the mobile terminal is operating in a phone call mode, the display unit 151 will provide a User Interface (UI) or a Graphic User Interface (GUI), which includes information associated with the call. As another example, if the mobile terminal is in a video call mode or a capturing mode, the display unit 151 may additionally or alternatively display images captured and/or received, UI, or GUI.

The display unit 151 may be implemented using, for example, at least one of a Liquid Crystal Display (LCD), a Thin Film Transistor-Liquid Crystal Display (TFT-LCD), an Organic Light-Emitting Diode (OLED), a flexible display, a three-dimensional (3D) display and an e-ink display.

Some of such displays 151 may be implemented as a transparent type or an optical transparent type through which the exterior is visible, which is referred to as ‘transparent display’. A representative example of the transparent display may include a Transparent OLED (TOLED), and the like. The rear surface of the display unit 151 may also be implemented to be optically transparent. Under this configuration, a user can view an object positioned at a rear side of a terminal body through a region occupied by the display unit 151 of the terminal body.

The display unit 151 may be implemented in two or more in number according to a configured aspect of the electronic device 100. For instance, a plurality of the displays 151 may be arranged on one surface to be spaced apart from or integrated with each other, or may be arranged on different surfaces.

The display unit 151 may also be implemented as a stereoscopic display unit 152 for displaying stereoscopic images.

Here, the stereoscopic image may be a three-dimensional (3D) stereoscopic image, and the 3D stereoscopic image is an image refers to an image making a viewer feel that a gradual depth and reality of an object on a monitor or a screen is the same as a reality space. A 3D stereoscopic image is implemented by using binocular disparity. Binocular disparity refers to disparity made by the positions of two eyes. When two eyes view different 2D images, the images are transferred to the brain through the retina and combined in the brain to provide the perception of depth and reality sense.

The stereoscopic display unit 152 may employ a stereoscopic display scheme such as stereoscopic scheme (a glass scheme), an auto-stereoscopic scheme (glassless scheme), a projection scheme (holographic scheme), or the like. Stereoscopic schemes commonly used for home television receivers, or the like, include Wheatstone stereoscopic scheme, or the like.

The auto-stereoscopic scheme includes, for example, a parallax barrier scheme, a lenticular scheme, an integral imaging scheme, or the like. The projection scheme includes a reflective holographic scheme, a transmissive holographic scheme, or the like.

In general, a 3D stereoscopic image is comprised of a left image (a left eye image) and a right image (a right eye image). According to how left and right images are combined into a 3D stereoscopic image, the 3D stereoscopic imaging method is divided into a top-down method in which left and right images are disposed up and down in a frame, an L-to-R (left-to-right, side by side) method in which left and right images are disposed left and right in a frame, a checker board method in which fragments of left and right images are disposed in a tile form, an interlaced method in which left and right images are alternately disposed by columns and rows, and a time sequential (or frame by frame) method in which left and right images are alternately displayed by time.

Also, as for a 3D thumbnail image, a left image thumbnail and a right image thumbnail are generated from a left image and a right image of the original image frame, respectively, and then combined to generate a single 3D thumbnail image. In general, thumbnail refers to a reduced image or a reduced still image. The thusly generated left image thumbnail and the right image thumbnail are displayed with a horizontal distance difference therebetween by a depth corresponding to the disparity between the left image and the right image on the screen, providing a stereoscopic space sense.

As illustrated, a left image and a right image required for implementing a 3D stereoscopic image is displayed on the stereoscopic display unit 152 by a stereoscopic processing unit (not shown). The stereoscopic processing unit may receive the 3D image and extract the left image and the right image, or may receive the 2D image and change it into a left image and a right image.

Here, if the display unit 151 and a touch sensitive sensor (referred to as a touch sensor) have a layered structure therebetween (referred to as a ‘touch screen’), the display unit 151 may be used as an input device as well as an output device. The touch sensor may be implemented as a touch film, a touch sheet, a touchpad, and the like.

The touch sensor may be configured to convert changes of a pressure applied to a specific part of the display unit 151, or a capacitance occurring from a specific part of the display unit 151, into electric input signals. Also, the touch sensor may be configured to sense not only a touched position and a touched area, but also touch pressure. Here, a touch object is an object to apply a touch input to the touch sensor. Examples of the touch object may include a finger, a touch pen, a stylus pen, a pointer or the like.

When touch inputs are sensed by the touch sensors, corresponding signals are transmitted to a touch controller. The touch controller processes the received signals, and then transmits corresponding data to the controller 180. Accordingly, the controller 180 may sense which region of the display unit 151 has been touched.

Still referring to FIG. 1, a proximity sensor 141 may be arranged at an inner region of the electronic device 100 covered by the touch screen, or near the touch screen. The proximity sensor 141 may be provided as one example of the sensing unit 140. The proximity sensor 141 indicates a sensor to sense presence or absence of an object approaching to a surface to be sensed, or an object disposed near a surface to be sensed, by using an electromagnetic field or infrared rays without a mechanical contact. The proximity sensor 141 has a longer lifespan and a more enhanced utility than a contact sensor.

The proximity sensor 141 may include a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and so on. When the touch screen is implemented as a capacitance type, proximity of a pointer to the touch screen is sensed by changes of an electromagnetic field. In this case, the touch screen (touch sensor) may be categorized into a proximity sensor.

Hereinafter, for the sake of brief explanation, a status that the pointer is positioned to be proximate onto the touch screen without contact will be referred to as ‘proximity touch’, whereas a status that the pointer substantially comes in contact with the touch screen will be referred to as ‘contact touch’. For the position corresponding to the proximity touch of the pointer on the touch screen, such position corresponds to a position where the pointer faces perpendicular to the touch screen upon the proximity touch of the pointer.

The proximity sensor 141 senses proximity touch, and proximity touch patterns (e.g., distance, direction, speed, time, position, moving status, etc.). Information relating to the sensed proximity touch and the sensed proximity touch patterns may be output onto the touch screen.

When a touch sensor is overlaid on the stereoscopic display unit 152 in a layered manner (hereinafter, referred to as ‘stereoscopic touch screen’), or when the stereoscopic display unit 152 and a 3D sensor sensing a touch operation are combined, the stereoscopic display unit 152 may also be used as a 3D input device.

As examples of the 3D sensor, the sensing unit 140 may include a proximity sensor 141, a stereoscopic touch sensing unit 142, an ultrasonic sensing unit 143, and a camera sensing unit 144.

The proximity sensor 141 detects the distance between a sensing object (e.g., the user's finger or a stylus pen) applying a touch by using the force of electromagnetism or infrared rays without a mechanical contact and a detect surface. By using the distance, the terminal recognizes which portion of a stereoscopic image has been touched. In particular, when the touch screen is an electrostatic touch screen, the degree of proximity of the sensing object is detected based on a change of an electric field according to proximity of the sensing object, and a touch to the 3D image is recognized by using the degree of proximity.

The stereoscopic touch sensing unit 142 is configured to detect the strength or duration of a touch applied to the touch screen. For example, the stereoscopic touch sensing unit 142 may sense touch pressure. When the pressure is strong, it may recognize the touch as a touch with respect to an object located farther away from the touch screen toward the inside of the terminal.

The ultrasonic sensing unit 143 is configured to recognize position information of the sensing object by using ultrasonic waves.

The ultrasonic sensing unit 143 may include, for example, an optical sensor and a plurality of ultrasonic sensors. The optical sensor is configured to sense light and the ultrasonic sensors may be configured to sense ultrasonic waves. Since light is much faster than ultrasonic waves, a time for which the light reaches the optical sensor is much shorter than a time for which the ultrasonic wave reaches the ultrasonic sensor. Therefore, a position of a wave generation source may be calculated by using a time difference from the time that the ultrasonic wave reaches based on the light as a reference signal.

The camera sensing unit 144 includes at least one of a camera, a photo sensor, and a laser sensor.

For example, the camera and the laser sensor may be combined to detect a touch of the sensing object with respect to a 3D stereoscopic image. When distance information detected by a laser sensor is added to a 2D image captured by the camera, 3D information can be obtained.

In another example, a photo sensor may be laminated on the mobile terminal. The photo sensor is configured to scan a movement of the sensing object in proximity to the touch screen. In detail, the photo sensor includes photo diodes and transistors at rows and columns to scan content mounted on the photo sensor by using an electrical signal changing according to the quantity of applied light. Namely, the photo sensor calculates the coordinates of the sensing object according to variation of light to thus obtain position information of the sensing object.

The audio output module 153 may convert and output as sound audio data received from the wireless communication unit 110 or stored in the memory 160 in a call signal reception mode, a call mode, a record mode, a voice recognition mode, a broadcast reception mode, and the like. Also, the audio output module 153 may provide audible outputs related to a particular function performed by the electronic device 100 (e.g., a call signal reception sound, a message reception sound, etc.). The audio output module 153 may include a speaker, a buzzer or the like.

The alarm unit 154 outputs a signal for informing about an occurrence of an event of the electronic device 100. Events generated in the mobile terminal may include call signal reception, message reception, key signal inputs, a touch input etc. In addition to video or audio signals, the alarm unit 154 may output signals in a different manner, for example, using vibration to inform about an occurrence of an event. The video or audio signals may be also outputted via the audio output module 153, so the display unit 151 and the audio output module 153 may be classified as parts of the alarm unit 154.

A haptic module 155 generates various tactile effects the user may feel. A typical example of the tactile effects generated by the haptic module 155 is vibration. The strength and pattern of the haptic module 155 can be controlled. For example, different vibrations may be combined to be outputted or sequentially outputted.

Besides vibration, the haptic module 155 may generate various other tactile effects such as an effect by stimulation such as a pin arrangement vertically moving with respect to a contact skin, a spray force or suction force of air through a jet orifice or a suction opening, a contact on the skin, a contact of an electrode, electrostatic force, etc., an effect by reproducing the sense of cold and warmth using an element that can absorb or generate heat.

The haptic module 155 may be implemented to allow the user to feel a tactile effect through a muscle sensation such as fingers or arm of the user, as well as transferring the tactile effect through a direct contact. Two or more haptic modules 155 may be provided according to the configuration of the electronic device 100.

The memory 160 may store software programs used for the processing and controlling operations performed by the controller 180, or may temporarily store data (e.g., a phonebook, messages, still images, video, etc.) that are inputted or outputted. In addition, the memory 160 may store data regarding various patterns of vibrations and audio signals outputted when a touch is inputted to the touch screen.

The memory 160 may include at least one type of storage medium including a Flash memory, a hard disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, and an optical disk. Also, the electronic device 100 may be operated in relation to a web storage device that performs the storage function of the memory 160 over the Internet.

The interface unit 170 serves as an interface with every external device connected with the electronic device 100. For example, the external devices may transmit data to an external device, receives and transmits power to each element of the electronic device 100, or transmits internal data of the electronic device 100 to an external device. For example, the interface unit 170 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating the authority of using the electronic device 100 and may include a user identity module (UIM), a subscriber identity module (SIM) a universal subscriber identity module (USIM), and the like. In addition, the device having the identification module (referred to as ‘identifying device’, hereinafter) may take the form of a smart card. Accordingly, the identifying device may be connected with the terminal 100 via the interface unit 170.

When the electronic device 100 is connected with an external cradle, the interface unit 170 may serve as a passage to allow power from the cradle to be supplied therethrough to the electronic device 100 or may serve as a passage to allow various command signals inputted by the user from the cradle to be transferred to the mobile terminal therethrough. Various command signals or power inputted from the cradle may operate as signals for recognizing that the mobile terminal is properly mounted on the cradle.

The controller 180 typically controls the general operations of the mobile terminal. For example, the controller 180 performs controlling and processing associated with voice calls, data communications, video calls, and the like. The controller 180 may include a multimedia module 181 for reproducing multimedia data. The multimedia module 181 may be configured within the controller 180 or may be configured to be separated from the controller 180.

The controller 180 may perform a pattern recognition processing to recognize a handwriting input or a picture drawing input performed on the touch screen as characters or images, respectively.

Also, the controller 180 may execute a lock state to restrict a user from inputting control commands for applications when a state of the mobile terminal meets a preset condition. Also, the controller 180 may control a lock screen displayed in the lock state based on a touch input sensed on the display unit 151 in the lock state of the mobile terminal.

The power supply unit 190 receives external power or internal power and supplies appropriate power required for operating respective elements and components under the control of the controller 180.

Various embodiments described herein may be implemented in a computer-readable or its similar medium using, for example, software, hardware, or any combination thereof.

For hardware implementation, the embodiments described herein may be implemented by using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic units designed to perform the functions described herein. In some cases, such embodiments may be implemented by the controller 180 itself.

For software implementation, the embodiments such as procedures or functions described herein may be implemented by separate software modules. Each software module may perform one or more functions or operations described herein.

Software codes can be implemented by a software application written in any suitable programming language. The software codes may be stored in the memory 160 and executed by the controller 180.

Hereinafter, a communication system which is operable with the electronic device 100 according to the present disclosure will be described.

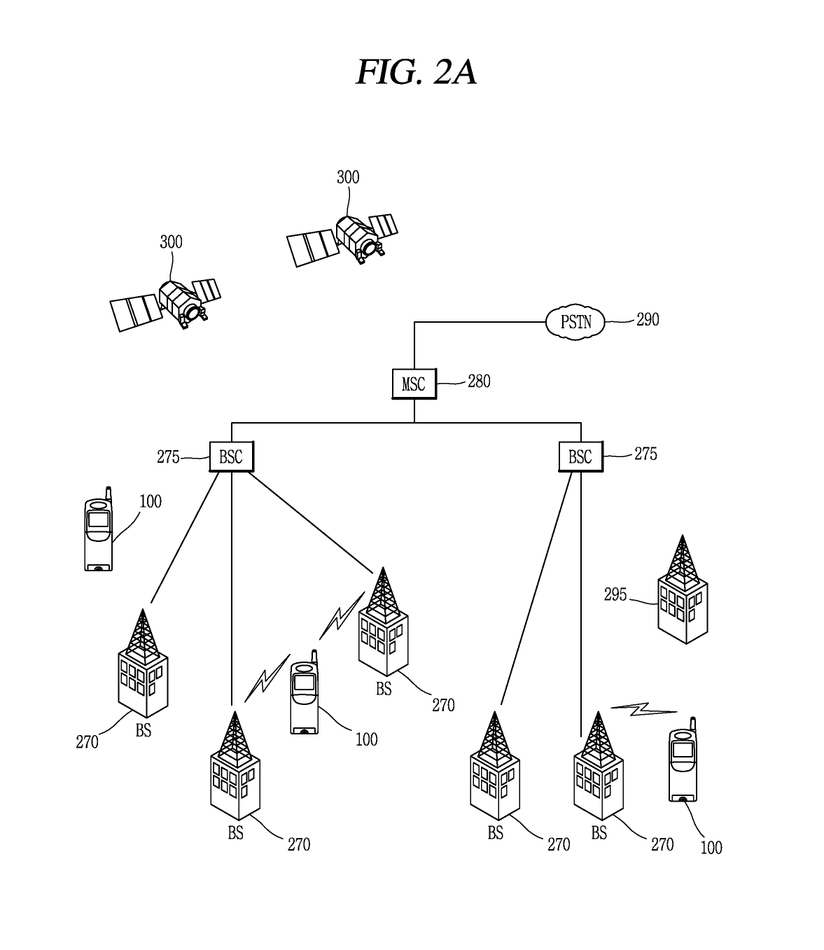

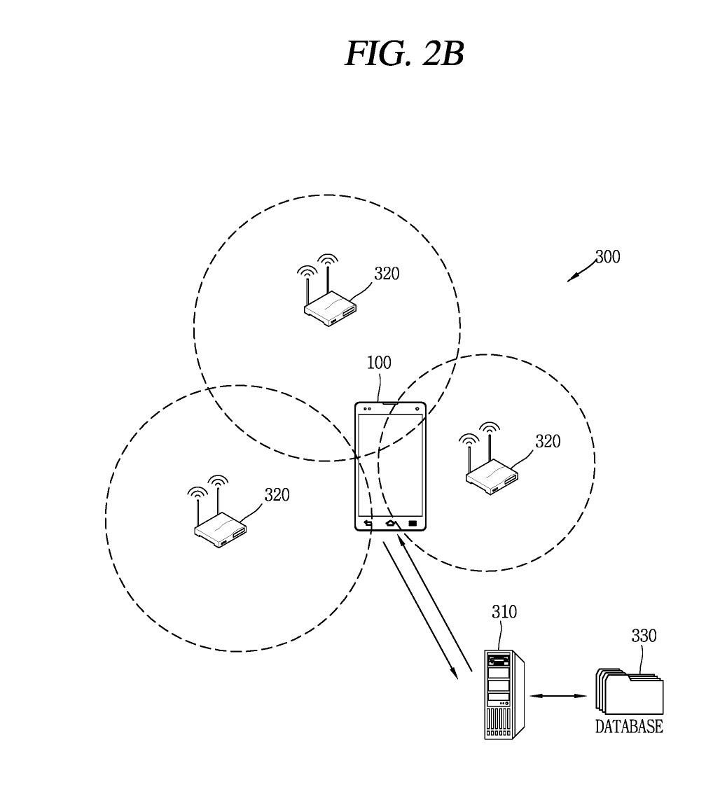

FIGS. 2A and 2B are conceptual views of a communication system operable with an electronic device 100 in accordance with the present disclosure.

First, referring to FIG. 2A, such communication systems utilize different air interfaces and/or physical layers. Examples of such air interfaces utilized by the communication systems include Frequency Division Multiple Access (FDMA), Time Division Multiple Access (TDMA), Code Division Multiple Access (CDMA), and Universal Mobile Telecommunications System (UMTS), the Long Term Evolution (LTE) of the UMTS, the Global System for Mobile Communications (GSM), and the like.

By way of non-limiting example only, further description will relate to a CDMA communication system, but such teachings apply equally to other system types including the CDMA wireless communication system.

Referring now to FIG. 2A, a CDMA wireless communication system is shown having a plurality of mobile terminal s 100, a plurality of base stations (BSs) 270, base station controllers (BSCs) 275, and a mobile switching center (MSC) 280. The MSC 280 is configured to interface with a conventional Public Switch Telephone Network (PSTN) 290. The MSC 280 is also configured to interface with the BSCs 275. The BSCs 275 are coupled to the base stations 270 via backhaul lines. The backhaul lines may be configured in accordance with any of several known interfaces including, for example, E1/T1, ATM, IP, PPP, Frame Relay, HDSL, ADSL, or xDSL. Hence, the plurality of BSCs 275 can be included in the system as shown in FIG. 2A.

Each base station 270 may include one or more sectors, each sector having an omni-directional antenna or an antenna pointed in a particular direction radially away from the base station 270. Alternatively, each sector may include two or more different antennas. Each base station 270 may be configured to support a plurality of frequency assignments, with each frequency assignment having a particular spectrum (e.g., 1.25 MHz, 5 MHz, etc.).

The intersection of sector and frequency assignment may be referred to as a CDMA channel. The base stations 270 may also be referred to as Base Station Transceiver Subsystems (BTSs). In some cases, the term “base station” may be used to refer collectively to a BSC 275, and one or more base stations 270. The base stations may also be denoted as “cell sites.” Alternatively, individual sectors of a given base station 270 may be referred to as cell sites.

A broadcasting transmitter (BT) 295, as shown in FIG. 2A, transmits a broadcast signal to the mobile terminals 100 operating within the system. The broadcast receiving module 111 (FIG. 1B) is typically configured inside the electronic device 100 to receive broadcast signals transmitted by the BT 295.

FIG. 2A further depicts several Global Positioning System (GPS) satellites 300. Such satellites 300 facilitate locating the position of at least one of plural mobile terminal s 100. Two satellites are depicted in FIG. 2, but it is understood that useful position information may be obtained with greater or fewer satellites than two satellites. The GPS module 115 (FIG. 1B) is typically configured to cooperate with the satellites 300 to obtain desired position information. It is to be appreciated that other types of position detection technology, (i.e., location technology that may be used in addition to or instead of GPS location technology) may alternatively be implemented. If desired, at least one of the GPS satellites 300 may alternatively or additionally be configured to provide satellite DMB transmissions.

During typical operation of the wireless communication system, the base stations 270 receive sets of reverse-link signals from various mobile terminal s 100. The mobile terminal s 100 are engaging in calls, messaging, and executing other communications. Each reverse-link signal received by a given base station 270 is processed within that base station 270. The resulting data is forwarded to an associated BSC 275. The BSC 275 provides call resource allocation and mobility management functionality including the orchestration of soft handoffs between base stations 270. The BSCs 275 also route the received data to the MSC 280, which then provides additional routing services for interfacing with the PSTN 290. Similarly, the PSTN 290 interfaces with the MSC 280, and the MSC 280 interfaces with the BSCs 275, which in turn control the base stations 270 to transmit sets of forward-link signals to the mobile terminal s 100.

Hereinafter, description will be given of a method for acquiring location information of a mobile terminal using a wireless fidelity (WiFi) positioning system (WPS), with reference to FIG. 2B.

The WiFi positioning system (WPS) 300 refers to a location determination technology based on a wireless local area network (WLAN) using WiFi as a technology for tracking the location of the electronic device 100 using a WiFi module provided in the electronic device 100 and a wireless access point 320 for transmitting and receiving to and from the WiFi module.

The WiFi positioning system 300 may include a WiFi location determination server 310, an electronic device 100, a wireless access point (AP) 320 connected to the electronic device 100, and a database 330 stored with any wireless AP information.

The WiFi location determination server 310 extracts the information of the wireless AP 320 connected to the electronic device 100 based on a location information request message (or signal) of the electronic device 100. The information of the wireless AP 320 may be transmitted to the WiFi location determination server 310 through the electronic device 100 or transmitted to the WiFi location determination server 310 from the wireless AP 320.

The information of the wireless AP extracted based on the location information request message of the electronic device 100 may be at least one of MAC address, SSID, RSSI, channel information, privacy, network type, signal strength and noise strength.

The WiFi location determination server 310 receives the information of the wireless AP 320 connected to the electronic device 100 as described above, and compares the received wireless AP 320 information with information contained in the pre-established database 330 to extract (or analyze) the location information of the electronic device 100.

On the other hand, referring to FIG. 2B, as an example, the wireless AP connected to the electronic device 100 is illustrated as a first, a second, and a third wireless AP 320. However, the number of wireless APs connected to the electronic device 100 may be changed in various ways according to a wireless communication environment in which the electronic device 100 is located. When the electronic device 100 is connected to at least one of wireless APs, the WiFi positioning system 300 can track the location of the electronic device 100.

Next, considering the database 330 stored with any wireless AP information in more detail, various information of any wireless APs disposed at different locations may be stored in the database 330.

The information of any wireless APs stored in the database 330 may be information such as MAC address, SSID, RSSI, channel information, privacy, network type, latitude and longitude coordinate, building at which the wireless AP is located, floor number, detailed indoor location information (GPS coordinate available), AP owner's address, phone number, and the like.

In this manner, any wireless AP information and location information corresponding to the any wireless AP are stored together in the database 330, and thus the WiFi location determination server 310 may retrieve wireless AP information corresponding to the information of the wireless AP 320 connected to the electronic device 100 from the database 330 to extract the location information matched to the searched wireless AP, thereby extracting the location information of the electronic device 100.

Furthermore, the extracted location information of the electronic device 100 may be transmitted to the electronic device 100 through the WiFi location determination server 310, thereby acquiring the location information of the electronic device 100.

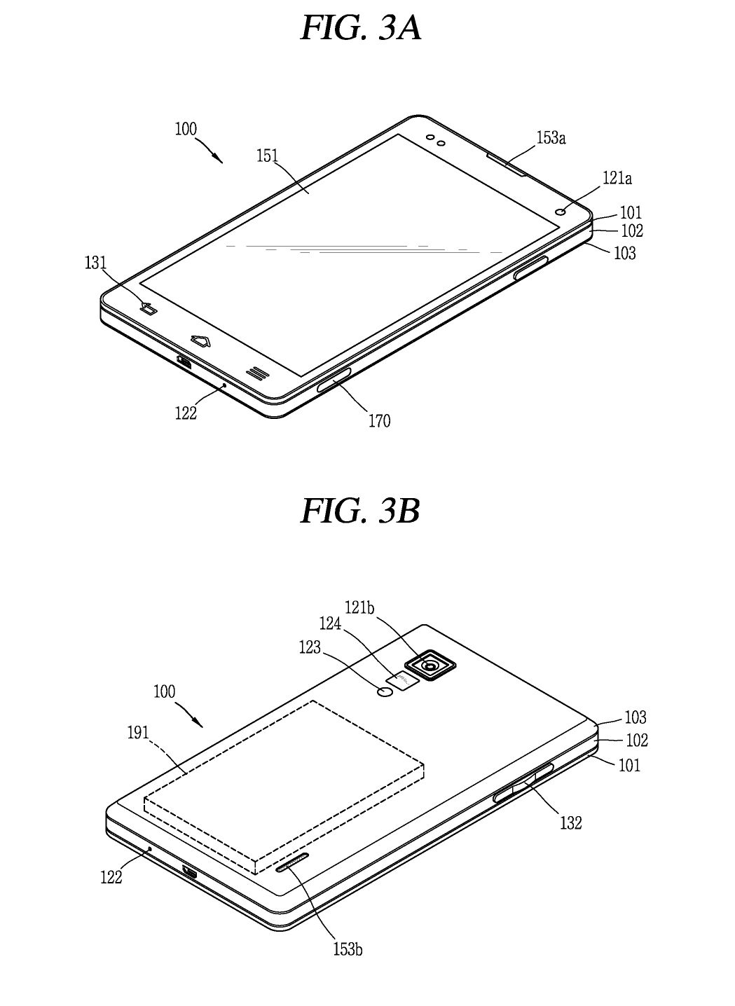

FIG. 3A is a front perspective view of a mobile terminal according to the present invention;

The electronic device 100 is described with reference to a bar-type terminal body. However, the electronic device 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof.

The electronic device 100 will generally include a case (for example, frame, housing, cover, and the like) forming the appearance of the terminal. In this embodiment, the case is formed using a front case 101 and a rear case 102. Various electronic components are incorporated into a space formed between the front case 101 and the rear case 102. At least one middle case may be additionally positioned between the front case 101 and the rear case 102. A rear cover 103 may be detachably coupled to the rear case 102.

The cases 101, 102, 103 may be formed by injection-molding synthetic resin or may be formed of a metal, for example, stainless steel (STS), aluminum (Al), titanium (Ti), or the like.

A display unit 151, a first audio output module 153a, a first camera 121a, a first manipulation unit 131, etc. are arranged on a front surface of the terminal body, and a microphone 122, an interface unit 170, a second manipulation unit 132, etc. are provided on a side surface of the terminal body.

The display unit 151 outputs information processed in the electronic device 100. The display unit 151 may be implemented using one or more suitable display devices. Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured to have a transmissive characteristic such that visual information output to the display unit 151 is visible, and may include a structure for enhancing visibility at a bright place. Referring to FIG. 3A, the display unit 151 occupies most parts of a front surface of the front case 101.

The first audio output module 153a and the first camera 121a are arranged at a region adjacent to one end among two ends of the display unit 151, and the first manipulation unit 131 and the microphone 122 are arranged at a region adjacent to another end among two ends of the display unit 151. The second manipulation unit 132 (refer to FIG. 3B), the interface unit 170, etc. may be disposed on a side surface of the terminal body.

The first audio output module 153a may be implemented in the form of a receiver to transmit a call sound to a user's ears, or a loud speaker to output alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies. In this case, a hole independently formed to output audio sounds may not be seen or is otherwise hidden in terms of appearance, thereby further simplifying the appearance and manufacturing of the electronic device 100.

The first camera 121a can process image frames such as still or moving images obtained by the image sensor in a capture mode or a video call mode. The processed image frames can then be displayed on the display unit 151.

The user input unit 130 configured to input a command for controlling an operation of the electronic device 100 may include first and second manipulation units 131 and 132. The first and second manipulation units 131 and 132 may also be commonly referred to as a manipulating portion, and may employ any tactile method that allows the user to perform manipulation such as touch, push, scroll, or the like.

In the drawings, the first manipulation unit 131 is implemented as a touch key, but possible alternatives include a mechanical key, a push key, a touch key, and combinations thereof.

Input received at the first and second manipulation units 131 and 132 may be used in various ways. For example, the first manipulation unit 131 may be used by the user to provide an input to a menu, home key, cancel, search, or the like, and the second manipulation unit 132 may be used by the user to provide an input to control a volume level being output from the first audio output modules 153a, to switch to a touch recognition mode of the display unit 151, or the like.

The microphone 122 is configured to receive a user's voice, other sound, etc. The microphone 122 may be provided at a plurality of regions to receive a stereo sound.

The interface unit 170 may serve as a path allowing the electronic device 100 to interface with external devices. For example, the interface unit 170 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the electronic device 100. The interface unit 170 may be implemented in the form of a socket for accommodating an external card, such as Subscriber Identification Module (SIM), User Identity Module (UIM), or a memory card for information storage.

FIG. 3B is a rear perspective view of the electronic device 100 shown in FIG. 3A.

Referring to FIG. 3B, a second camera 121b may be additionally mounted to a rear surface of the terminal body, i.e., the rear case 102. The second camera 121b includes an image capturing direction that is substantially opposite to the image capturing direction of the first camera unit 121a. The second camera 121b may have different pixels from the first camera 121a.

For example, the first camera 121a may operate with relatively lower pixels (lower resolution). Thus, the first camera 121a may be useful when a user can capture his face and send it to another party during a video call or the like. On the other hand, the second camera 121b may operate with a relatively higher pixels (higher resolution) such that it can be useful for a user to obtain higher quality pictures for later use. The first and second cameras 121a and 121b may be installed at the terminal body so as to rotate or pop-up.

A flash 123 and a mirror 124 (not shown) may be additionally disposed close to the second camera 121b. The flash 123 operates in conjunction with the second camera 121b when taking a picture using the second camera 121b. The mirror 124 can cooperate with the second camera 121b to allow a user to photograph himself in a self-portrait mode.

A second audio output unit 153b may be additionally arranged on a rear surface of the terminal body. The second audio output unit 153b may cooperate with the first audio output unit 153a (refer to FIG. 3A) so as to implement a stereo function. Also, the second audio output unit 153b may be configured to operate as a speakerphone.

Not only an antenna for calling, but also a broadcast signal receiving antenna (not shown) may be additionally disposed on a side surface of the terminal body. The antenna which configures a part of the broadcast receiving module 111 (refer to FIG. 1) may be retractable into the terminal body.

A power supply unit 190 (refer to FIG. 1) for supplying power to the electronic device 100 is provided at the terminal body. The power supply unit 190 may include a battery 191, which is mounted in the terminal body or detachably coupled to an outside of the terminal body. The rear cover 103 is shown coupled to the rear case 102 for shielding the battery 191, to prevent separation of the battery 191, and to protect the battery 191 from an external impact or from foreign material.

Furthermore, the extracted location information of the electronic device 100 may be transmitted to the electronic device 100 through the WiFi location determination server 310, thereby acquiring the location information of the electronic device 100.

Hereinafter, will be explained electronic devices operable by interworking with the electronic device of the present invention, based on a reciprocal authentication.

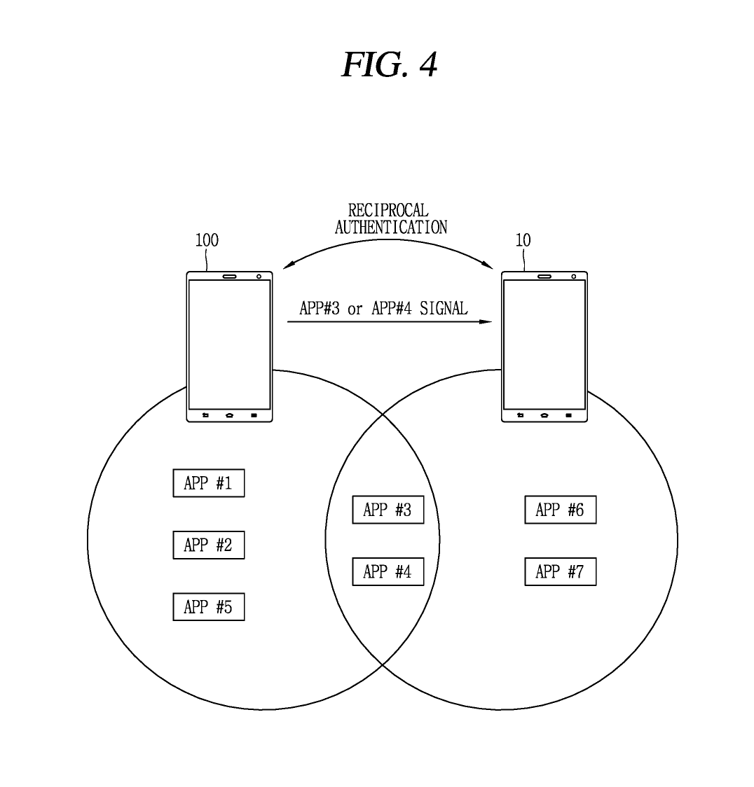

FIG. 4 is a conceptual view illustrating a connection relation between an electronic device 100 with another electronic device 10, according to an embodiment of the present invention.

The electronic device 100 includes a wired/wireless communication unit configured to execute wired/wireless communication with another electronic device 10, and a control unit configured to execute an interworking function with said another electronic device 10 by cooperating with the wired/wireless communication unit.

A network to connect the electronic device 100 to said another electronic device 10 may be various types of computer networks which may be connected to each other in a wired or wireless manner, or may be a wireless network.

For instance, the wireless network may be at least one of a wireless personal area network, a wireless local area network, a wireless mesh network, a wireless metropolitan area network, a wireless wide area network, and a cellular network. Alternatively, the wireless network may be a personal area network (PAN) which connects the electronic device 100 with said another electronic device 10.

The wireless personal area network (WPAN) may execute a PAN by a wireless network technology such as infrared ray communication (IrDA), a wireless USB, Bluetooth, Z-wave, ZigBee, a body area network, a near field communication (NFC), and an ultrasonic wave communication. The PAN may be executed by a wired computer bus such as a USB and firewire. Alternatively, the PAN may be executed by a near field communication (NFC).

The electronic device 100 and said another electronic device 10 may be also connected to each other by using at least one of Wi-Fi (Wireless-Fidelity) and Wi-Fi direct, as well as the aforementioned ones.

The electronic device 100 and said another electronic device 10 shown in FIG. 4 may communicate with each other by a 3G or 4G network. However, the present invention is not limited to this. The electronic device 100 and said another electronic device 10 may be wirelessly connected to each other by a 2G or next-generation communication method. A wireless network is not limited to the aforementioned ones.

The electronic device 100 is connected to said another electronic device 10 in a wired or wireless manner, thereby being reciprocally authenticated. And the authentication is completed before the interworking function is executed. The reciprocal authentication with said another electronic device 10 is a precondition to execute the interworking function. In the present invention, reciprocal authentication means an operation to authenticate the electronic device 100 and said another electronic device 10 for reliability, and to provide the electronic device 100 and said another electronic device 10 with a right to execute interworking functions.

Applications (APP#1, APP#2, APP#3, APP#4, APP#5) executable in the electronic device 100 are installed at the electronic device 100. And non-installed applications may be downloaded from an external server, or may be installed through other path. The applications executable in the electronic device 100 indicate all types of application programs. The applications include not only application programs operated by being installed in the electronic device, but also services provided from a web through a web browser without being installed in the electronic device 100.

Applications (APP#3, APP#4, APP#6, APP#7) executable in said another electronic device 10 are installed at the said another electronic device 10. Some of the applications may be provided from a web through a web browser without being installed in said another electronic device 10.

For convenience, each of the electronic device 100 and said another electronic device 10 may be represented as a set, and the applications executable in the electronic device 100 and said another electronic device 10 may be represented as elements included in the sets.

The electronic device 100 and said another electronic device 10 may include not only applications (APP#1, APP#2, APP#5, APP#6, APP#7) executable only in the electronic device 100 and said another electronic device 10, but also applications (APP#3, APP#4) executable in the electronic device 100 and said another electronic device 10 by interworking. Such applications are represented as an intersection in FIG. 4.

The applications executable in the electronic device 100 and said another electronic device 10 by interworking mean applications which influence on not only the electronic device 100 but also said another electronic device 10, by change of the applications generated from one of the two electronic devices 100, 10 which transceive (transmit and receive) data with each other through wired/wireless communication.

For instance, under an assumption that the electronic device 100 and said another electronic device 10 execute any applications using wired/wireless communication, an input to the electronic device 100 may be output to the electronic device 100, and to said another electronic device 10 reciprocally authenticated with the electronic device 100 by being connected in a wired/wireless manner. In this case, the applications may be applications executable by interworking.

The applications executable in the electronic device 100 and said another electronic device 10 by interworking may be the same applications, or may be different applications. For instance, in a case where an application such as an electronic game is executed in the electronic device 100 and said another electronic device 10 by interworking, the electronic game is performed by executing the same application program. Thus, the interworking application is the same application. On the other hand, an application to control said another electronic device 10 may be executed in the electronic device 100, and an application to be controlled by the electronic device 100 may be executed in said another electronic device 10. In this case, an application for inputting a control command, and an application for receiving a control command are different applications. However, if the different applications are interworked with each other, it means that the application executed in the electronic device 100 and the application executed in said another electronic device 10 correspond to each other.

The applications executable by interworking (e.g., APP#3, APP#4 in FIG. 4) are not determined arbitrarily, but are determined based on a preset criterion by the electronic device 100 and said another electronic device 10. The preset criterion may be at least one of a type and the number of the electronic device 100 and said another electronic device 10, a communication method between the electronic device 100 and said another electronic device 10, a hardware and a software supported by the electronic device 100 and said another electronic device 10, and a reciprocal authentication level. Thus, such criteria correspond to characteristics of the electronic device 100 and said another electronic device 10, and an application executable by interworking may be determined according to the characteristics of the electronic device 100 and said another electronic device 10. The determined application is used to determine an interworking function between the electronic device 100 and said another electronic device 10.

The electronic device 100 transmits a signal generated from the determined application to said another electronic device 10, such that an application corresponding to the determined application is executed in said another electronic device 10 for interworking, when the determined application is executed.

The signal generated from the determined application may include an execution command of the corresponding application, such that the corresponding application is executed in said another electronic device 10. Alternatively, the signal may be a signal which provides recommendation information for recommending a corresponding application to said another electronic device 10.

The electronic device 100 is reciprocally authenticated with said another electronic device 10. Thus, once the signal about an application executable by interworking is transmitted to said another electronic device 10 from the electronic device 100, said another electronic device 10 receives the signal from the electronic device 100 without an additional authentication process. Then, said another electronic device 10 is operated by interworking with the electronic device 100. The interworking between the electronic device 100 and said another electronic device 10 is executed based on a right provided based on reciprocal authentication.

In an electronic device system including a plurality of electronic devices, the electronic device 100 may be referred to as a first electronic device, and said another electronic device 10 may be referred to as a second electronic device.

Hereinafter, an interworking operation between the electronic device 100 and said another electronic device 10 shown in FIG. 4 will be explained.

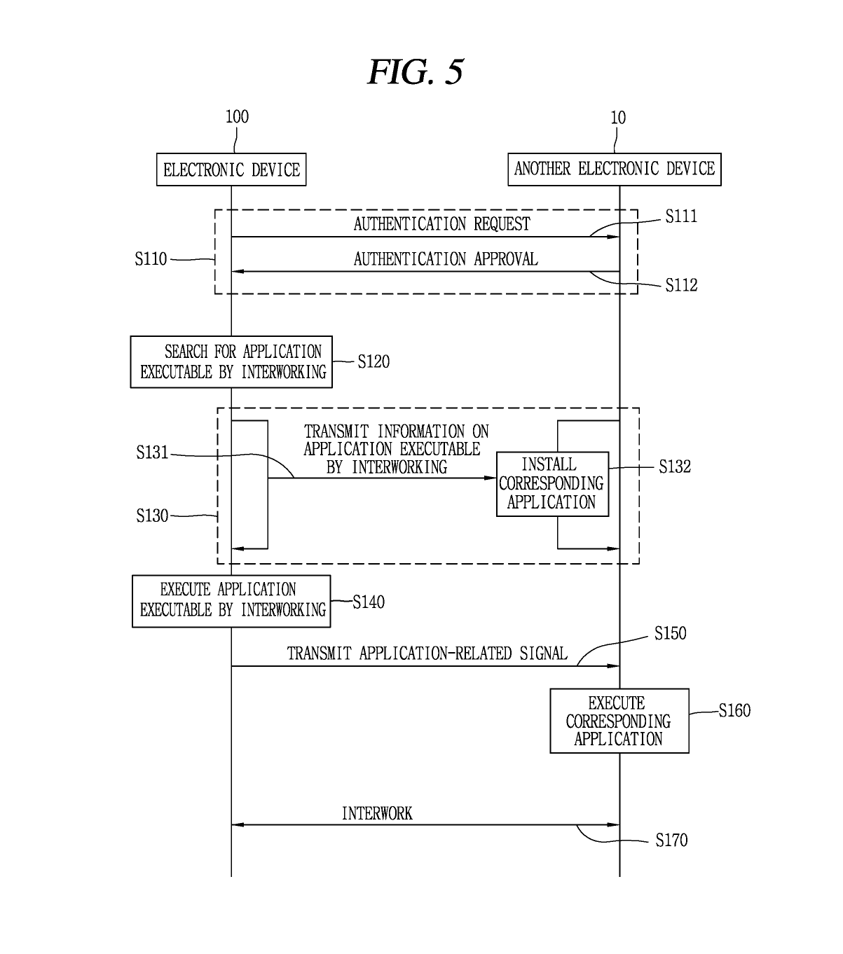

FIG. 5 is a flowchart illustrating that the electronic device 100 of the present invention is operated by interworking with said another electronic device 10, based on the connection relation between the electronic devices shown in FIG. 4.

In an electronic device system composed of the electronic device 100 and said another electronic device 10, the electronic device 100 and said another electronic device 10 completes a reciprocal authentication before an interworking function is executed (S110).

Since the interworking function of the electronic device 100 and said another electronic device 10 is based on reciprocal authentication, an authentication process is firstly completed, and then an interworking operation is executed without an additional authentication process.

The authentication process may be executed as the electronic device 100 requests authentication from said another electronic device 10 by wired/wireless communication (S111), and said another electronic device 10 transmits an approval to the electronic device 100 through wired/wireless communication (S112).

The reason why authentication is required before an interworking operation is executed is because execution of an application on the electronic device 100 influences on an operation of said another electronic device 10. For instance, in a case where the electronic device 100 receives a control command and said another electronic device 10 is operated by receiving the control command by wired/wireless communication, the operation of said another electronic device 10 is controlled by the electronic device 100. Therefore, a right to control said another electronic device 10 is provided to the electronic device 100 through an authentication process. An interworking function between the electronic device 100 and said another electronic device 10 is executable only between the electronic devices having completed an authentication process, and is not executed between the electronic device 100 and a non-authenticated external electronic device.

This is not limited to the application which transmits or receives a control command, but may be applicable to all applications executable by interworking in the electronic device 100 and said another electronic device 10.

Next, the electronic device 100 determines an application executable by interworking with said another electronic device 10, based on a preset criterion (S120). The preset criterion may be at least one of a type and the number of the electronic device 100 and said another electronic device 10, a communication method with said another electronic device 10, a hardware and a software supported by said another electronic device 10, and a reciprocal authentication level.

Hereinafter, will be explained a criteria to determine an application executable by interworking.

The electronic device 100 and said another electronic device 10 may be mobile terminals such as a portable phone, a smartphone, a tablet PC and a wearable device, or may be all types of electronic devices such as a refrigerator, a cleaner, a washing machine, a television, a wireless printer, and a personal computer (PC) where a wired/wireless communication module may be mounted. An application executable by interworking may be determined according to a type of the electronic device 100 and said another electronic device 10.

For instance, in a case where a mobile terminal and another mobile terminal are wirelessly connected to each other to be reciprocally authenticated, the application executable by interworking may be a mobile game operated in a mobile terminal through wireless communication, a social network service (SNS), a video call, a message transmission (SMS, MMS, etc.), a voice recognition, an application to share files such as still images or moving images, an application to capture still images and moving images (camera application), etc. However, such applications are merely exemplary, and the present invention is not limited to this.

As another example, in a case where a mobile terminal and a wireless printer are wirelessly connected to each other to be reciprocally authenticated, the mobile terminal may have a file sending application, an application to control the wireless printer, an application to display a result outputted from the wireless printer or a result to be output from the wireless printer on a display, etc. as the application executable by interworking, and the wireless printer may have a file receiving application, an application to receive a control command from the mobile terminal, an application to print a received text or image file, etc. as the application executable by interworking. In this case, the applications operated in the mobile terminal and the wireless printer by interworking may not the same applications, but may be applications corresponding to each other.

As another example, in a case where a mobile terminal and a robot cleaner are wirelessly connected to each other to be reciprocally authenticated, the mobile terminal may have an application to control the robot cleaner, an application to output a capturing screen of a camera installed at the robot cleaner to a display unit of the mobile terminal, etc. as the application executable by interworking, and the robot cleaner may have an application to receive a control command from the mobile terminal, an application to capture a moving path of the robot cleaner by a camera, etc. as applications executable by interworking with the mobile terminal.

The application executable by interworking may be determined according to a type of the electronic device 100 and said another electronic device 10. If one of the electronic device 100 and said another electronic device 10 has a type change, the application executable by interworking may be also changed.

The application executable by interworking may be changed according to the number of the electronic device 100 and said another electronic device 10 wirelessly connected to each other to be reciprocally authenticated.

For instance, in a case where a mobile terminal and two televisions are wirelessly connected to each other to be reciprocally authenticated, the mobile terminal may have an application to capture still images or moving images by a camera, and an application to send captured still images or moving images, as the application executable by interworking. In this case, the two televisions may have an application to receive files from the mobile terminal, an application to output received files in a dual mode, etc. as the application executable by interworking.

The application executable by interworking may be determined according to the number of the electronic device 100 and said another electronic device 10. The application executable by interworking may be changed when the electronic device 100 or said another electronic device 10 is excluded, or when other electronic devices are added to the electronic device 100 and said another electronic device 10.

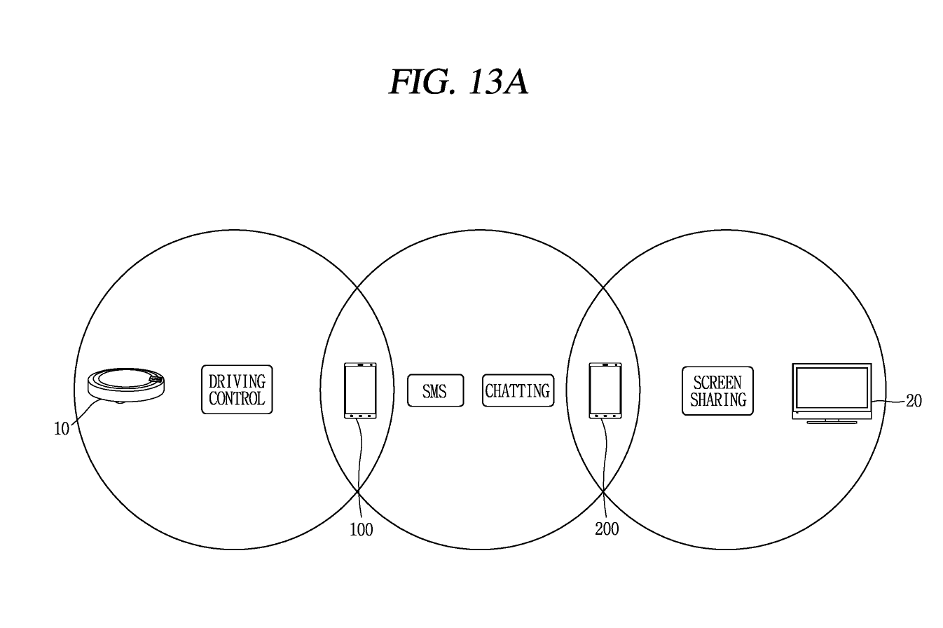

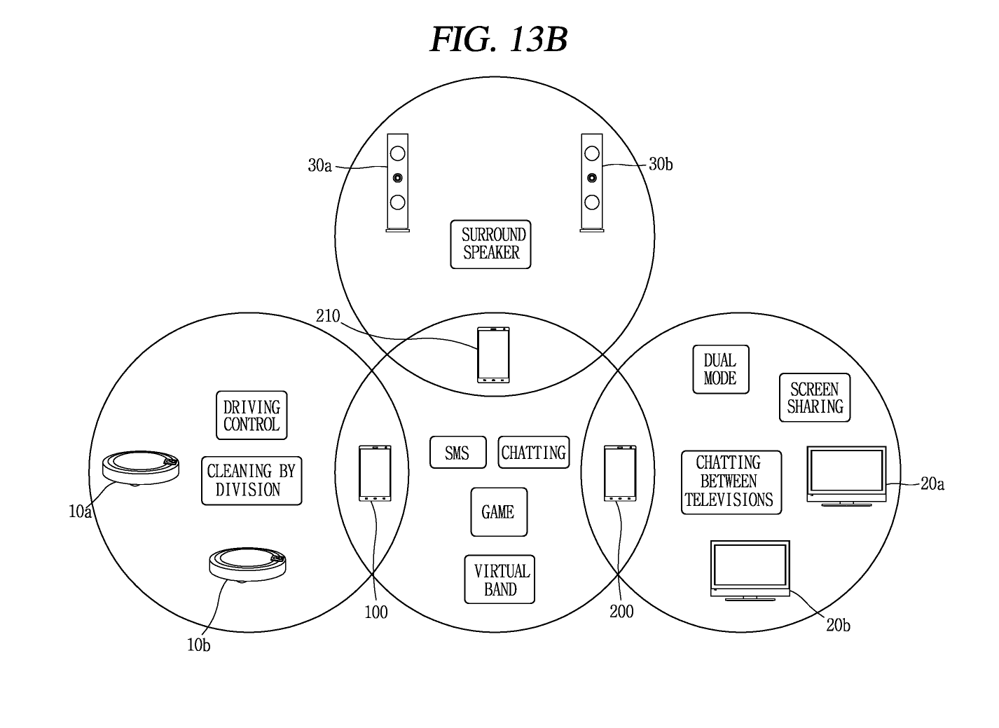

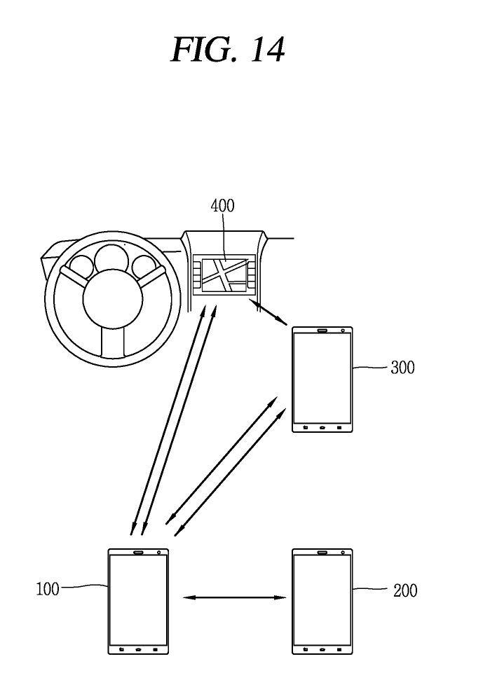

An embodiment to determine an application executable by interworking according to a type and the number of the electronic device 100 and said another electronic device 10 will be explained in more detail with reference to FIGS. 13A and 13B.

The application executable by interworking may be also determined according to a communication method of the electronic device 100 and said another electronic device 10. The communication method varies according to a wired type or a wireless type, a bandwidth of a network, a channel environment, etc., and an application to be supported may be determined according to a network state.

For instance, when two mobile terminals are wirelessly connected to each other, the application executable by interworking may be changed according to whether the two mobile terminals are connected to each other via Bluetooth or via Wi-Fi. In a case where the two mobile terminals are connected to each other via Bluetooth, applications to send and receive texts or photos may be operated by interworking, but applications to send and receive moving images of a high capacity are restricted from being used. On the other hand, in a case where the two mobile terminals are connected to each other via Wi-Fi, not only applications to transmit and receive (transceive) texts or photos, but also applications to send and receive moving images of a high capacity may be operated by interworking.

As another example, in an environment where data of a high capacity can be transceived due to an excellent network connection state, an audio file of high quality and a video file of high picture quality (e.g., a level close to full-HD digital broadcasting quality) may be transmitted or received. On the other hand, in an environment having a poor network connection state, an audio file of low quality and a video file of low picture quality (e.g., video streaming of a low level) may be transmitted or received. Thus, an application to transceive data in an electronic device and another electronic device may be determined according to a network connection state.

The application executable by interworking may be determined according to a hardware and a software supported by the electronic device 100 and said another electronic device 10. By hardware, the application executable by interworking may be changed according to whether the electronic device 100 or said another electronic device 10 has an input device such as a keyboard and a mouse, according to whether the electronic device 100 or said another electronic device 10 has a sensor such as an acceleration sensor, an infrared ray sensor and a gyro sensor, according to whether a touch input is supported or not, according to whether the electronic device 100 or said another electronic device 10 has a camera, and according to whether the electronic device 100 or said another electronic device 10 has a microphone. The application executable by interworking may be changed according to whether an image output unit or an audio output unit exists or not, according to a function of the image output unit or the audio output unit, and according to a function of a central processing unit (CPU), a graphic processing unit (GPU), etc.

By software, the application executable by interworking may be changed according to software supported by the electronic device 100 and said another electronic device 10, such as SMS, an MMS, a web browser, a camera, an alarm, a calculator, contact information, an e-mail, a calendar, photos, videos, a clock and multimedia software.

The application executable by interworking may be changed according to a reciprocal authentication level of the electronic device 100 and said another electronic device 10. Users of the electronic device 100 and said another electronic device 10 may determine a reciprocal authentication level during an authentication process, and functions interworked in the electronic device 100 and said another electronic device 10 may be changed according to the reciprocal authentication level.

For instance, in a case where the electronic device 100 has two applications executable by interworking with said another electronic device 10, one application may be used according to a reciprocal authentication level, but another application may not be used unless authentication of a higher level is completed. In this case, a right to use the applications by the electronic device 100 and said another electronic device 10 is provided according to a reciprocal authentication level.

More specifically, in a case where a mobile terminal and a robot cleaner are wirelessly connected to each other to be reciprocally authenticated and applications executable by interworking are a control application and an application to share images captured by a camera, it may be set to share the images captured by the camera of the robot cleaner, but not to control the robot cleaner by the mobile terminal. In case of controlling the robot cleaner by the mobile terminal, authentication of a higher level should be completed. Thus, the applications executable by interworking may be determined based on an authentication level.

The applications executable by interworking may be changed according to whether the electronic device 100 and said another electronic device 10 belong to the same owner, and according to whether there is a record about applications already-authenticated or shared.

If the electronic device 100 and said another electronic device 10 belong to the same owner, a reciprocal authentication level may be set such that all applications may be sharable, and applications executable by interworking may be executed and operated anytime without an additional operation.

Whether to use the same application or similar applications may be determined based on a record about applications already-authenticated or shared.

Once an application executable by interworking is determined based on a preset criterion, an installation procedure may be performed according to whether an application corresponding to the determined application has been installed at said another electronic device 10 or not (S130). If a corresponding application has not been installed at said another electronic device 10, the electronic device 100 transmits information on the application executable by interworking, to said another electronic device 10 (S131). However, such a step is executed when an application executable by interworking has not been installed at said another electronic device 10. Thus, such a step may be omitted when an application executable by interworking has been installed at said another electronic device 10.

The electronic device 100 may firstly transmit information on the application executable by interworking, to said another electronic device 10, for execution of the application. Alternatively, said another electronic device 10 may firstly request for information on the application executable by interworking, and then the electronic device 100 having received the request may transmit information on the application executable by interworking as a response.

The information transmitted to said another electronic device 10 may include a list of applications executable by interworking, an internet address of a server downloadable from said another electronic device 10, etc. Once the information on the application executable by interworking is transmitted to said another electronic device 10, said another electronic device 10 may download an application corresponding to the application from an external server, based on the received information (S132).

Next, the electronic device 100 executes the application executable by interworking with said another electronic device 10, based on a user input (S140). Once the application executable by interworking is executed in the electronic device 100, a signal related to the application executable by interworking is transmitted to said another electronic device 10, such that a corresponding application is executed in said another electronic device 10 for interworking (S150).

The signal may include an execution command of a corresponding application, such that the corresponding application may be executed in said another electronic device 10. In this case, said another electronic device 10 having received the signal may execute the corresponding application without receiving an additional execution command according to an authentication level (S160). Alternatively, said another electronic device 10 may execute the corresponding application based on approval by a user input, according to a reciprocal authentication level between the electronic device 100 and said another electronic device 10.

Such a process may be omitted when the corresponding application has been already executed in said another electronic device 10, and when said another electronic device 10 is in a standby state in a wired/wireless communicable state with the electronic device 100.

If the corresponding application has been already executed in said another electronic device 10, and if the corresponding application is executed by an execution command, the electronic device 100 and said another electronic device 10 are operated by interworking (S170). The electronic device 100 and said another electronic device 10 transmit and receive (transceive) a signal with each other. The signal may be all types of signals to use an interworking function by the electronic device 100 and said another electronic device 10. For instance, the signal may include all types of signals to share texts, photos or videos with said another electronic device 10, or to use hardware or software of said another electronic device 10.

Hereinafter, the electronic device 100 aforementioned in FIGS. 4 and 5, an electronic device system including the electronic device 100 and said another electronic device 10, and a method of controlling the electronic device 100 will be explained.

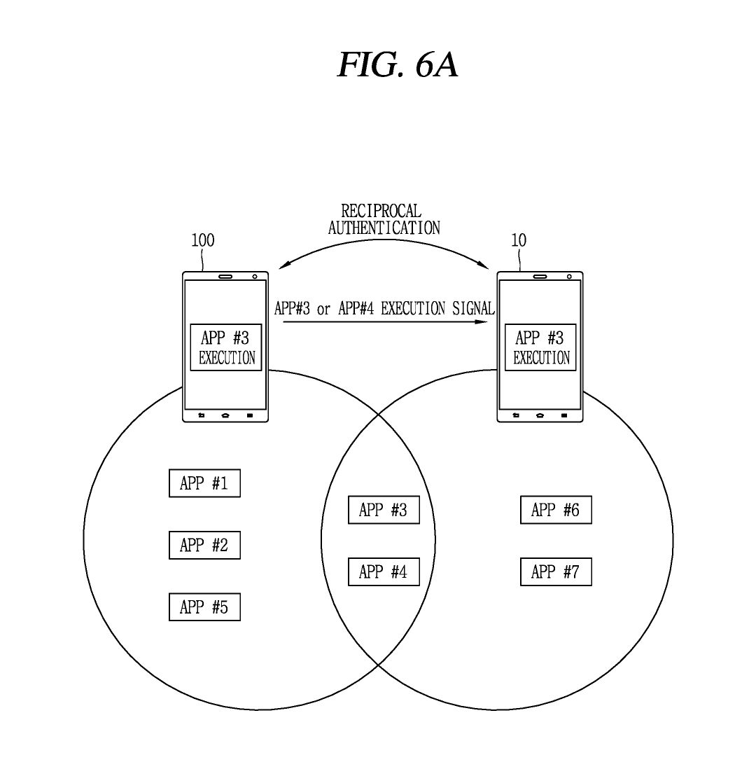

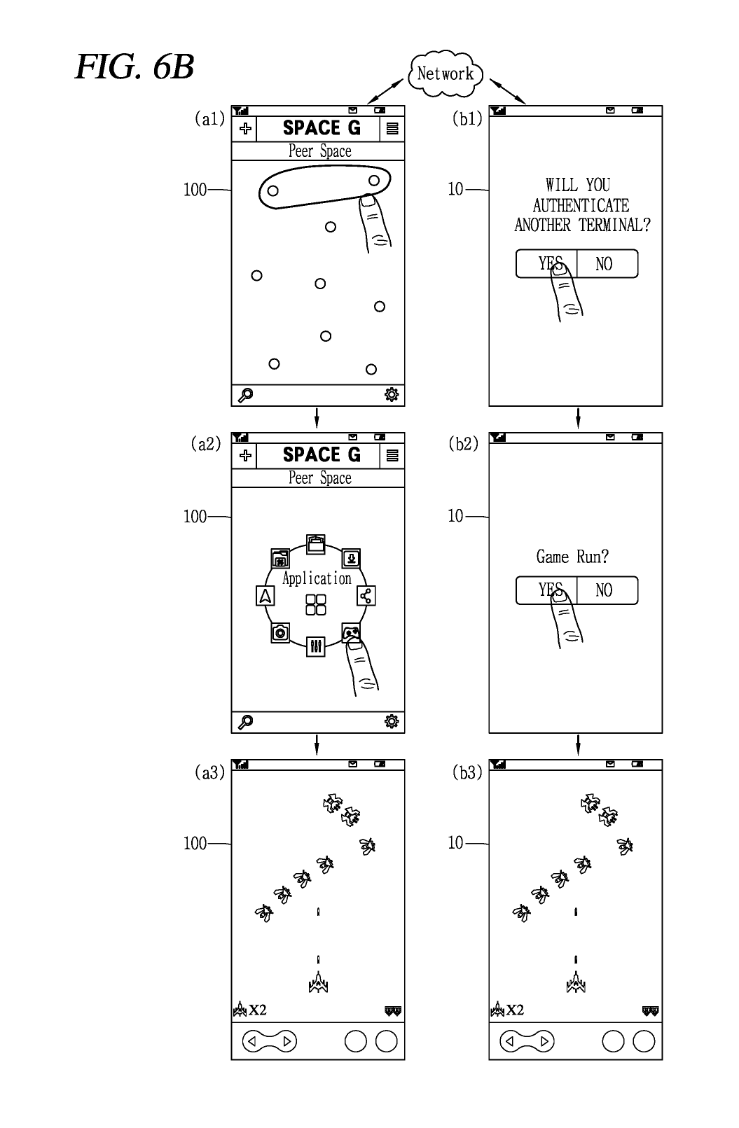

FIGS. 6A and 6B are conceptual views illustrating a process of transmitting an execution command of an application executable by interworking, to said another electronic device 10 based on an authenticated connection, according to an embodiment of the present invention.

Referring to FIG. 6A, the electronic device 100 and said another electronic device 10 are in a wirelessly connected state after being reciprocally authenticated. Applications (APP#1, APP#2, APP#3, APP#4, APP#5) executable in the electronic device 100 are arranged as elements of a set of the electronic device 100, and applications (APP#3, APP#4, APP#6, APP#7) executable in said another electronic device 10 are also arranged as elements of a set of said another electronic device 10. Applications (APP#3, APP#4) executable in the electronic device 100 and said another electronic device 10 by interworking are represented in the form of an intersection.

Upon execution of at least one (APP#3) among the applications (APP#3, APP#4) executable in the electronic device 100 by interworking, a signal related to the application executable by interworking (APP#3) is transmitted to said another electronic device 10. Then, in said another electronic device 10 having received the signal, the application executable by interworking (APP#3) is executed without input of an additional execution command. Such a process is executed under an assumption that the electronic device 100 and said another electronic device 10 are authenticated with each other at a level where applications are executable without an additional execution command or authentication process.

Next, FIG. 6B illustrates that interworked functions of the electronic device 100 and said another electronic device 10 are executed by two mobile terminals wirelessly-connected to each other.

(a1)) to (a3) illustrate a display unit of a mobile terminal corresponding to the electronic device 100, and (b1) to (b3) illustrate a display unit of a mobile terminal corresponding to said another electronic device 10.

Referring to (a1), a list of wirelessly-connectable other electronic devices is output to the display unit of the electronic device. And a signal to request reciprocal authentication may be transmitted to at least one of the plurality of other electronic devices 10. As shown, the signal transmission may be executed through a user interface for an operation to connect said another electronic device 10 output to the display unit, with the electronic device 100.

Referring to (b1), upon reception of a signal to request for a reciprocal authentication from the electronic device 100, said another electronic device 10 may output a selection window inquiring whether to accept a reciprocal authentication. As a user accepts the reciprocal authentication, the electronic device 100 and said another electronic device 10 complete the reciprocal authentication. The electronic device 100 and said another electronic device 10 may determine an authentication level during a reciprocal authentication process.

Next, referring to (a2), a list of applications executable by interworking with said another electronic device 10 wirelessly-connected to the electronic device 100 may be output to the electronic device 100, and one of the applications may be executed based on a user input.

Referring to (b2), a signal related to interworking applications is transmitted to said another electronic device 10 from the electronic device 100, and said another electronic device 10 executes a corresponding application. The application may be executable based on a user's acceptance as shown.

Referring to (a3) and (b3), the same application is operated by interworking in the electronic device 100 and said another electronic device 10, and the electronic device 100 and said another electronic device 10 may maintain an interworking operation by continuously transceiving a signal related to the application with each other until the application is terminated.

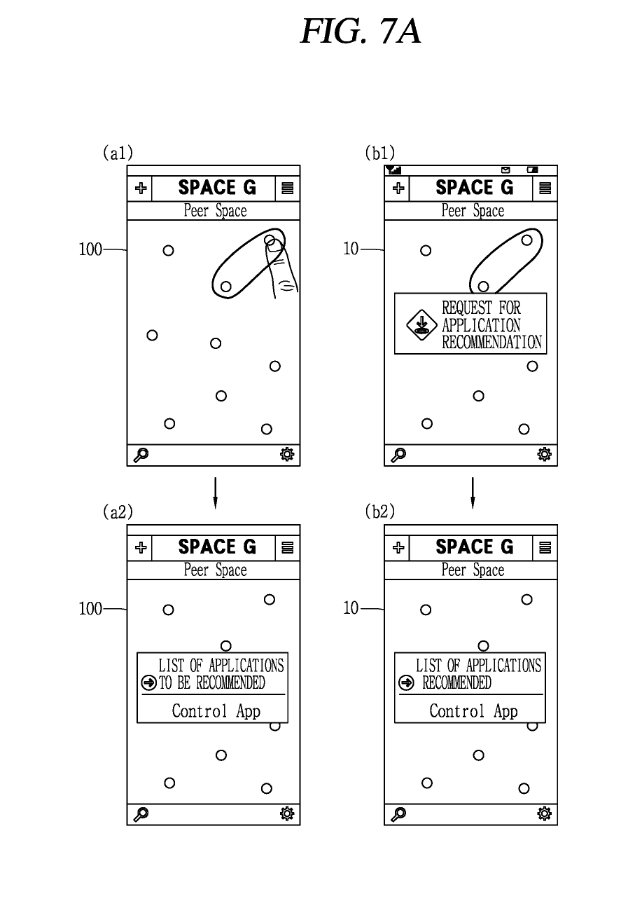

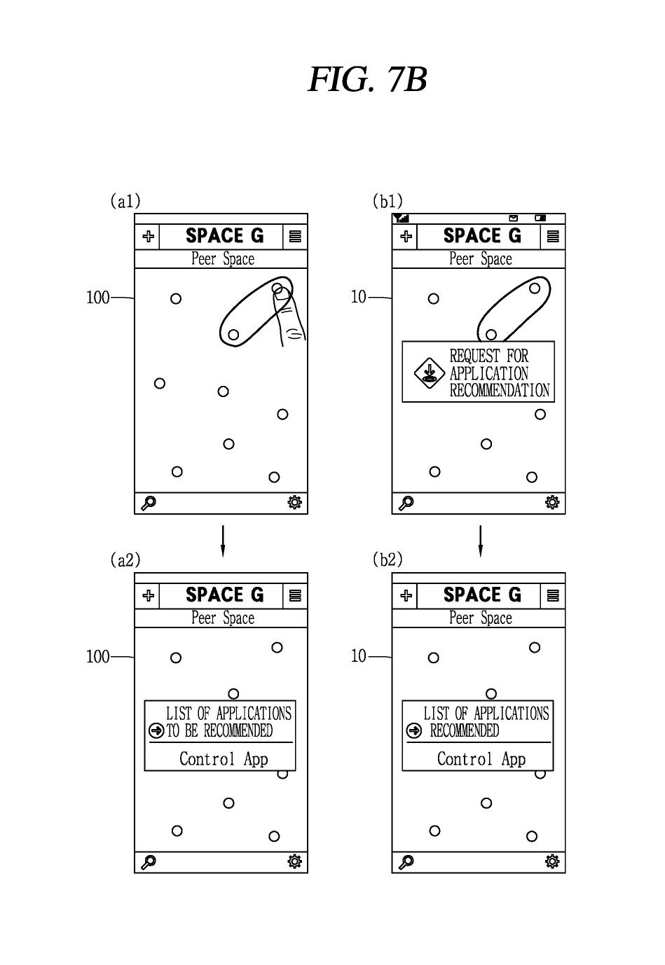

FIGS. 7A and 7B are conceptual views illustrating a process of transmitting recommendation information with respect to an application executable by interworking, to another electronic device, according to an embodiment of the present invention.

If an application executable by interworking with the electronic device 100 has not been installed at said another electronic device 10, the electronic device 100 may transmit, to said another electronic device 10, a signal about application installation. The signal transmission may be executed by a wired/wireless communication unit controlled by a controller.

A process of recommending an application executable by interworking to said another electronic device 10 by the electronic device 100 may be performed as said another electronic device 10 requests the electronic device 100 to recommend an application, and as the electronic device 100 responds to the request.

As shown in FIG. 7A, in a case where the electronic device 100 is a mobile terminal and said another electronic device 10 is a cleaner having a wireless communication module, an application executable by interworking may be a control application to control the cleaner by the mobile terminal.

However, in a case where the control application has not been installed at the cleaner, the cleaner may request the mobile terminal to recommend an application executable by interworking after completion of a reciprocal authentication with the mobile terminal. And the mobile terminal may recommend a control application as the application executable by interworking, and may transmit a signal related to recommendation information to the cleaner. Then, the cleaner having received the control application may install the control application by downloading from an internet address of a server included in the recommendation information transmitted from the mobile terminal. After completion of the installation, the cleaner may be operated by interworking with the mobile terminal. The installation of the application may be executed through a user's approval.

The present invention includes a mechanism to select an application executable by interworking with said another electronic device 10 by a user of the electronic device 100, and to transmit a signal of the selected application to said another electronic device 10. Further, the present invention includes a mechanism to determine an application executable by interworking with said another electronic device 10, based on a preset criterion, and to recommend the determined application to said another electronic device 10.

Such a mechanism is to provide an application executable by interworking in a reverse direction unlike in the conventional art, according to a characteristic of the electronic devices. This is because applications executable by interworking in the electronic device 100 and said another electronic device 10 is determined not by a user's selection, but by a preset criterion. With such a configuration, optimum applications executable in the electronic device 100 and said another electronic device 10 authenticated with each other may be provided according to characteristics of the electronic device 100 and said another electronic device 10.

Such a process will be explained in more detail as follows. Once the electronic device 100 accesses a network, a daemon program informs said another electronic device 10 of existence of an application, on the network, by using a multicast. Then, said another electronic device 10 receives the information, thereby being provided with an application executable by interworking by recommendation.

Referring to FIG. 7B, (a1)) and (a2) illustrate the display unit of the electronic device 100, and (b1) and (b2) illustrate said another electronic device 10 wirelessly-connected to the electronic device 100.

Referring to (a1), the electronic device 100 requests wireless connection and reciprocal authentication with said another electronic device 10. Then, if said another electronic device 10 accepts the reciprocal authentication, the reciprocal authentication between the electronic device 100 and said another electronic device 10 is completed.

Referring to (b1), said another electronic device 10 requests the electronic device 100 to recommend an application executable by interworking, since the application executable by interworking with the electronic device 100 has not been installed at said another electronic device 10. The request from said another electronic device 10 may be executed based on a user's input, and a signal is transmitted to the electronic device 100 through wireless communication when the request is input.

Referring to (a2), the electronic device 100 recommends a determined control application based on a preset criterion. Referring to (b2), said another electronic device 10 is provided with the control application from the electronic device 100 by recommendation. Then, the control application is installed at said another electronic device 10, and said another electronic device 10 executes an interworking operation with the electronic device 100 by receiving a control command from the electronic device 100 through the control application.

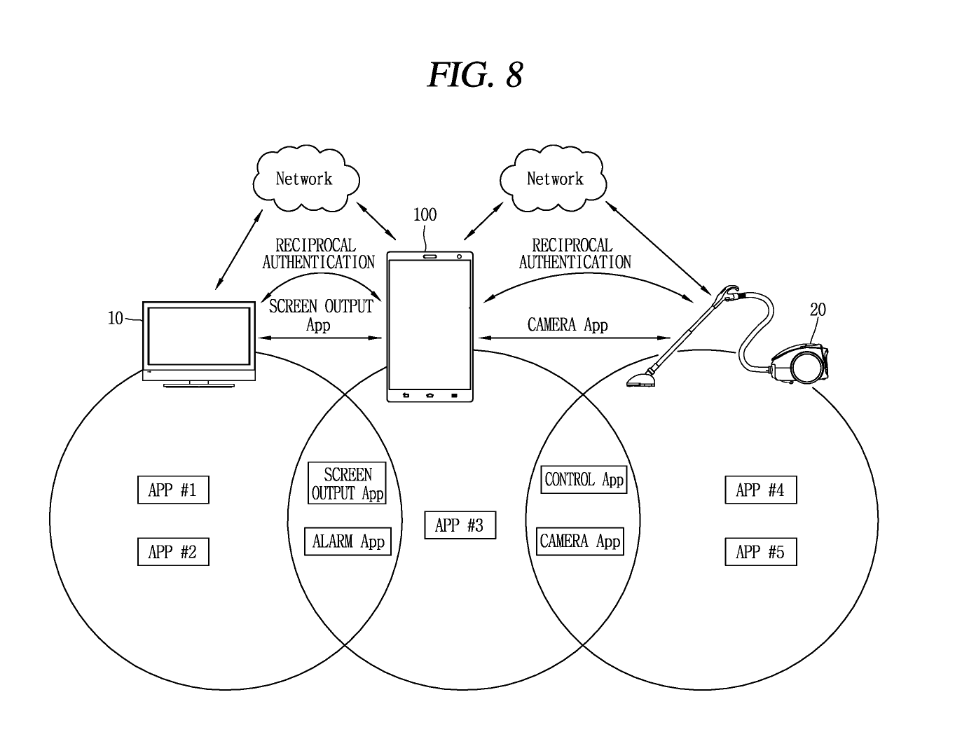

Next, a connection relation among a plurality of electronic devices in an electronic device system including the plurality of electronic devices will be explained with reference to FIG. 8.

FIG. 8 is a conceptual view illustrating a connection relation between the electronic device 100 and other electronic devices 10, 20 according to another embodiment of the present invention.

The electronic device 100 may be wirelessly connected to the plurality of other electronic devices 10, 20 to thus be reciprocally authenticated.

The plurality of other electronic devices 10, 20 may be wirelessly connected to the electronic device 100 through different networks, and each of the plurality of other electronic devices 10, 20 may be provided with applications executable by interworking with the electronic device 100 (a screen output App, a notification App, a control App and a camera App). In this case, applications executable by interworking with the electronic device 100 in said other electronic devices 10, 20 may be the same, or may be different from each other as shown.

The electronic device 100 may be reciprocally authenticated with said other electronic devices 10, 20 simultaneously or sequentially. For instance, the electronic device 100 may be firstly authenticated with one of said other electronic devices (e.g., 10), and then may be authenticated with another of them (e.g., 20). In this case, the electronic device 100 determines applications executable with the plurality of other electronic devices 10, 20, based on a preset criterion. Then, when at least one of the determined applications is executed, an application-related signal is transmitted to one of the plurality of other electronic device (10 or 20) where applications executable with the determined applications are installed.

For instance, as shown in FIG. 8, in a case where the electronic device 100 is a mobile terminal and said other electronic device 10, 20 are a television and a cleaner, the mobile terminal 100 may be wirelessly connected and reciprocally authenticated with the television 10 and the cleaner 20, through different networks.

If the mobile terminal 100 and the television 10 are firstly authenticated with each other, a screen output application and a notification application may be executed by interworking in the mobile terminal 100 and the television 10. An image output to the mobile terminal 100 may be also output to the television 10. And screen information output to the television 10 may be transmitted to a user of the mobile terminal 100 through the notification application.

Upon completion of the authentication between the mobile terminal 100 and the cleaner 20, the mobile terminal 100 newly determines applications executable by interworking. The determined applications are a control application and a camera application executable with the cleaner 20. The mobile terminal 100 may be operated by interworking with not only the television 10 but also the cleaner 20. Applications executable by interworking with the plurality of other electronic devices may be executable by interworking with one of the plurality of other electronic devices (10 or 20) as shown. Alternatively, applications may be commonly executable by interworking in the electronic device 100 and the plurality of other electronic devices 10, 20.

The electronic device 100 may be connected to one (10) of the plurality of other electronic devices 10, 20, and may transmit a signal related to an executable application to another (20) of them, in order to interwork the plurality of other electronic devices 10, 20 with each other.

For instance, referring to FIG. 8, the mobile terminal 100 may transmit, to the television 10, screen information of a camera application executable by interworking with the cleaner 20. Thus, an image captured by a camera of the cleaner 20 may be transmitted to the television 10 via the mobile terminal 100, and may be output to a display unit of the television 10. In this case, there are no applications executable by interworking between the television 10 and the cleaner 20. However, the mobile terminal 100 serves as a bridge for connecting the television 10 and the cleaner 20 with each other.

Referring to the descriptions with reference to FIG. 8, a plurality of electronic devices may be controlled according to a purpose, in an assumption that the plurality of electronic devices are authenticated with each other. An electronic device, connected to a plurality of other electronic devices, may share images, files, music, etc. with one of the plurality of other electronic devices, and may backup files stored therein to another of them. In this case, it is assumed that said another electronic device is provided with a storage medium.

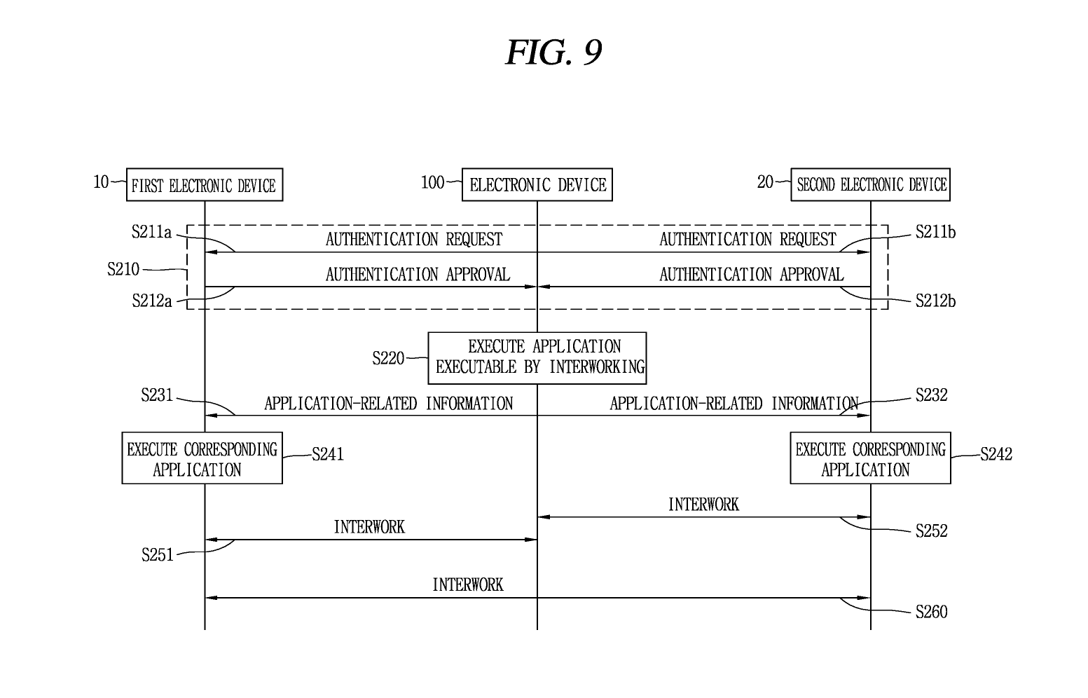

FIG. 9 is a flowchart illustrating that the electronic device 100 of the present invention is operated by interworking with a plurality of other electronic devices 10, 20, based on the connection relation among the electronic devices shown in FIG. 8.

Firstly, the electronic device 100 is authenticated with the plurality of other electronic devices 10, 20 (S210). Authentication requests (S211a, S211b) may be simultaneously or sequentially transmitted to the plurality of other electronic devices. Once authentication approvals (S212a, S212b) are transmitted from the plurality of other electronic devices 10, 20, the electronic device 100 is completely authenticated with the plurality of other electronic devices 10, 20. The authentication approvals (S212a, S212b) by the plurality of other electronic devices 10, 20 may be also executed simultaneously or sequentially.

Then, the electronic device 100 determines applications executable by interworking, based on a preset criterion, and the determined applications are executed according to a user's input (S220).

The applications executable by interworking may be determined according to characteristics of the plurality of other electronic devices 10, 20. The applications executable by interworking may include not only applications executable by interworking in the plurality of other electronic devices 10, 20, but also applications executable by interworking in one of the plurality of other electronic devices 10, 20.

Next, the electronic device 100 transmits a signal related to the applications executable by interworking, to each of the plurality of other electronic devices 10, 20 (S231, S232). Then, each of the plurality of other electronic devices 10, 20 receives a signal including an execution command, and executes a corresponding application (S241, S242). The electronic device 100 and the plurality of other electronic devices 10, 20 are operated by interworking (S251, S252).

Finally, the electronic device 100 receives an application-related signal from one of the plurality of other electronic devices 10, 20, and transmits the received signal to another of them, for interworking between the plurality of other electronic devices 10, 20. The electronic device 100 serves as a bridge, and the plurality of other electronic devices 10, 20 may be operated by interworking through the electronic device 100.

In an electronic device system including a plurality of electronic devices, the electronic device 100 may be referred to as a first electronic device, and the plurality of other electronic devices 10, 20 may be referred to as second and third electronic devices.

Hereinafter, a process of operating the electronic device 100 as a bridge, in an electronic device system including a plurality of electronic devices will be explained in more detail.

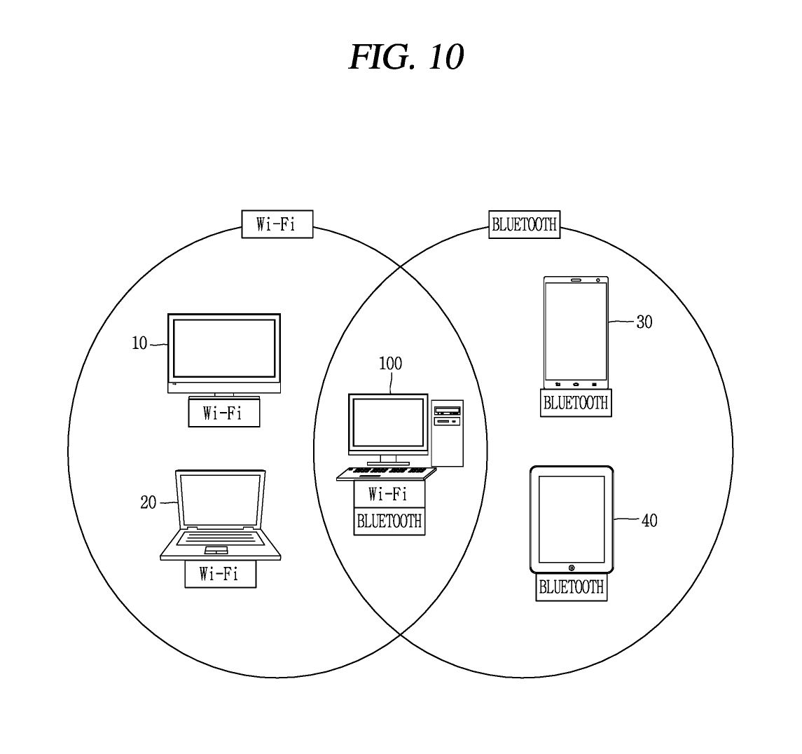

FIG. 10 is a conceptual view illustrating a connection relation and interworking among a plurality of electronic devices connected to each other through different networks.

In an electronic device system, a plurality of electronic devices 100, 10, 20, 30, 40 may be the aforementioned electronic device 100 or other electronic device 10. The plurality of electronic devices 100, 10, 20, 30, 40 may be connected to each other through different networks. For instance, the plurality of electronic devices 100, 10, 20, 30, 40 may be connected to each other via Wi-Fi or Bluetooth. However, the present invention is not limited to this. That is, the plurality of electronic devices 100, 10, 20, 30, 40 may be connected to each other by wire.

The electronic devices 100, 10, 20 connected to each other via Wi-Fi may be operated by interworking with only the electronic devices 100, 10, 20 connected to each other via Wi-Fi, and the electronic devices 100, 30, 40 connected to each other via Bluetooth may be operated by interworking with only the electronic devices 100, 30, 40 connected to each other via Wi-Fi.

For instance, as shown in FIG. 10, a PC 100, a television 10 and a notebook 20 may be wirelessly connected to each other via Wi-Fi, and the PC 100, a mobile phone 30 and a tablet PC 40 may be wirelessly connected to each other via Bluetooth. In this case, physical communication cannot be performed between different networks. However, as shown in FIG. 9, the electronic devices connected to different networks may be operated by interworking through the PC 100 which belongs to the two networks. And the PC 100 may serve as a bridge for connecting the electronic devices which belong to the different networks to each other.

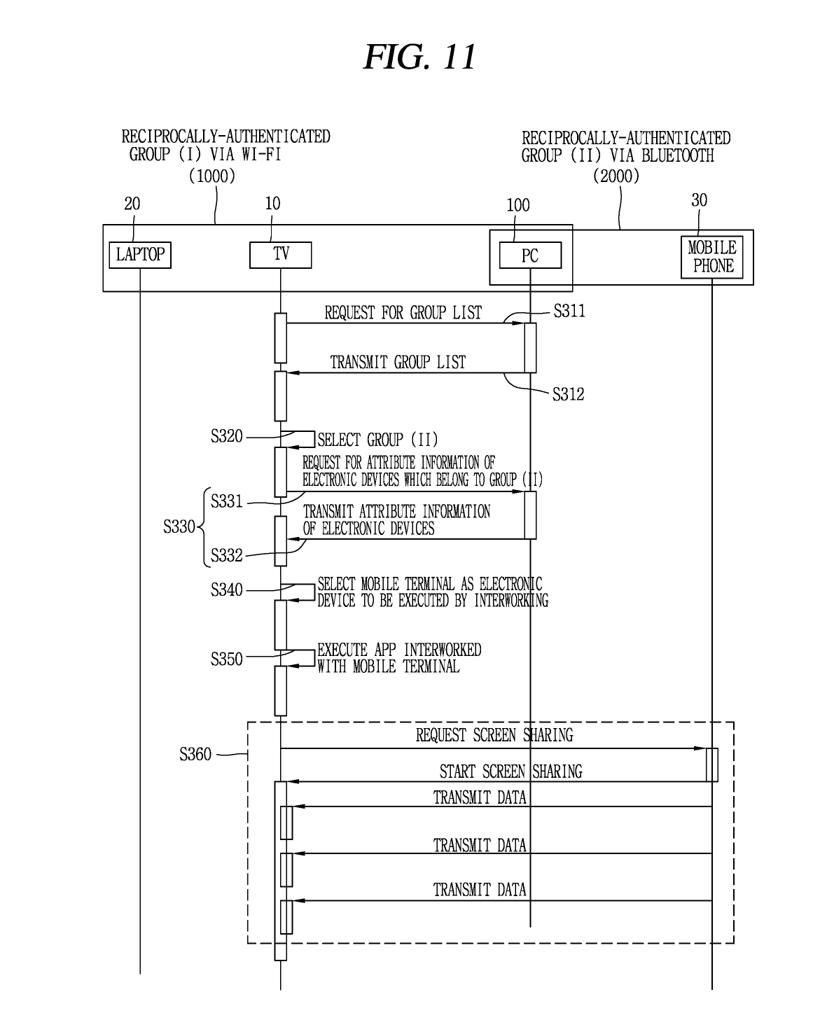

A method of controlling the electronic device 100 which serves as a bridge will be explained in more detail with reference to FIG. 11.

FIG. 11 is a flowchart illustrating that the electronic device 100 of the present invention is operated by interworking with the plurality of other electronic devices 10, 20, 30, based on the connection relation between the electronic devices 100, 10, 20, 30 shown in FIG. 10.

The PC 100, the television 10 and the notebook 20 may be wirelessly connected to each other via Wi-Fi, thereby forming a reciprocally-authenticated group 1000. And the PC 100 and the mobile phone 30 may be wirelessly connected to each other via Bluetooth, thereby forming a reciprocally-authenticated group 2000.

If the television 10 which belongs to the reciprocally-authenticated group 1000 via Wi-Fi requests a group list from the PC 100 (S311), the PC 100 transmits a list of the electronic devices which belong to the reciprocally-authenticated group 2000 via Bluetooth (S312).

Then, if the television 10 selects the reciprocally-authenticated group 2000 by a user's input (S320), the television 10 requests attribute information of the electronic devices which belong to the reciprocally-authenticated group 2000, from the PC 100 (S331). Then, the PC 100 responds to the request (S332).

Next, the television 10 selects the mobile phone 30 as an electronic device to be executed by interworking, by a user's input (S340). Then, the television 10 executes an application executable by interworking with the mobile phone 30, based on the attribute information received from the PC 100 (S350). In the drawing, the application is configured as a screen sharing application.

The television and the mobile terminal are connected to different networks, but they are interworked with each other through the PC 100 which serves as a bridge (S360). If the television 10 sends a screen sharing request to the PC 100, the PC 100 transmits the screen sharing request to the mobile phone 30. Then, if the mobile phone 30 responds to the screen sharing request, the PC 100 transmits the response to the television 10 thereby to interconnect the television 10 and the mobile phone 30 with each other. Then, the television 10 receives data from the mobile phone 30 through the PC 100, and the television 10 may output images captured by the mobile phone 30.

As aforementioned, the electronic device 100 may serve as a bridge in groups connected to different networks, thereby interconnecting the plurality of other electronic devices 10, 20, 30 which belong to different groups, with each other.

Hereinafter, an interworking operation of a plurality of electronic devices will be explained by applying the aforementioned present invention.

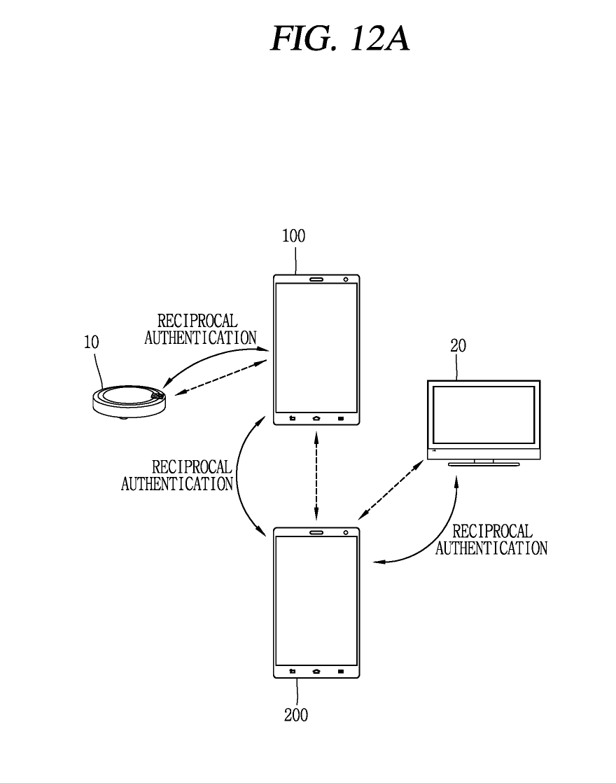

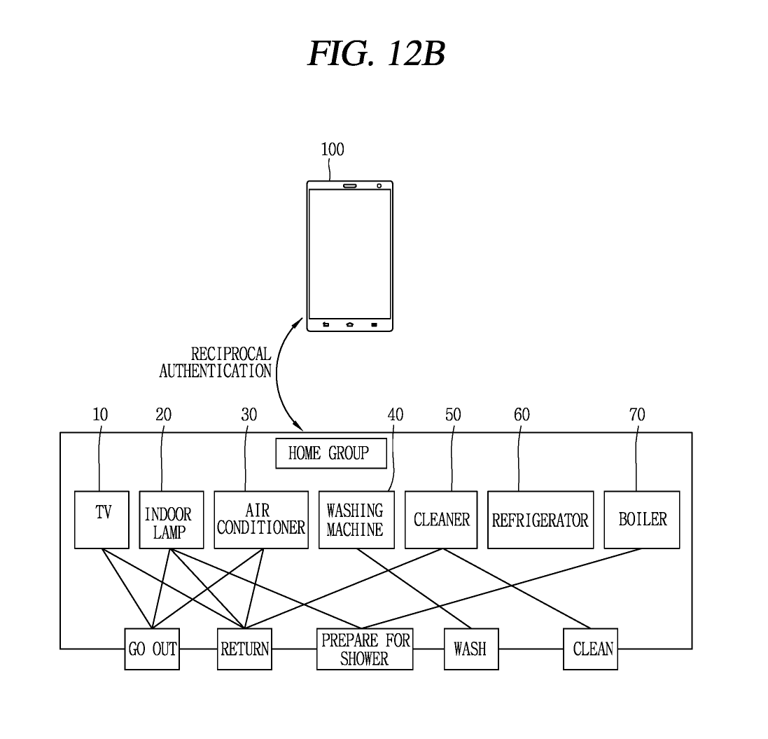

FIGS. 12A and 12B are conceptual views illustrating that a plurality of electronic devices are operated by interworking based on a reciprocally authenticated connection.

Referring to FIG. 12A, an electronic device 100 may be wirelessly connected to other electronic devices 10, 20 to thus be reciprocally authenticated. In this case, the electronic device 100 may be interworked with an electronic device 200, in an assumption that they are reciprocally authenticated with each other.

For instance, as shown, the mobile terminal 100 may be interworked with the robot cleaner 10 through reciprocal authentication, and is authenticated with another mobile terminal 200. Likewise, said another mobile terminal 200 is authenticated with the mobile terminal 100, and is authenticated with the television 20. In this case, the two mobile terminals 100, 200 may serve as a bridge for interconnecting the robot cleaner 10 and the television 20 with each other, and the number of the electronic devices 100, 200 authenticated with each other may be increased according to a user's selection.

Extending electronic devices authenticated with each other will be explained with reference to FIG. 12B.

A television 10, an indoor lamp 20, an air conditioner 30, a washing machine 40, a cleaner 50, a refrigerator 60 and a boiler 70 are shown as other electronic devices which can be reciprocally authenticated with the mobile terminal 100. At least one of the shown electronic devices may be excluded, or another electronic device may be added to the illustrated electronic devices to form a home group.

Each of the electronic devices 10, 20, 30, 40, 50, 60, 70 may be wirelessly connected to the mobile terminal 100 through at least one network (e.g., Wi-Fi or Bluetooth). The mobile terminal 100 may be authenticated with all of the electronic devices 10, 20, 30, 40, 50, 60, 70, and more than two mobile terminals 100, 200 (200 is not shown in FIG. 12B) may be authenticated with at least part of the electronic devices 10, 20, 30, 40, 50, 60, 70. The mobile terminal 100 may be used as an electronic device for controlling said other electronic devices.

In case of adding the mobile terminal 100 authenticated with a home group including said other electronic devices 10, 20, 30, 40, 50, 60, 70 to a network, or in case of applying a user's input to the mobile terminal 100 added to the network, said other electronic devices 10, 20, 30, 40, 50, 60, 70 may be operated according to a preset scenario under control of the mobile terminal 100.

For instance, if the authenticated mobile terminal 100 is added to a network as a user of the mobile terminal 100 enters home, the mobile terminal 100 transmits a signal related to an interworking application (e.g., a control application) to the television 10, the indoor lamp 20, the air conditioner 30 and the cleaner 50, according to a return scenario. Then, the television 10, the indoor lamp 20, the air conditioner 30 and the cleaner 50 having received the signal may be switched on to be operated, based on an execution command included in the signal.

Such an operation is executed under an assumption that the electronic device 100 and said other electronic devices 10, 20, 30, 40, 50, 60, 70 are reciprocally authenticated with each other. It can be seen that an interworking operation is executable in said other electronic devices 10, 20, 30, 40, 50, 60, 70 when the present invention is applied.

On the contrary, if the mobile terminal 100 included in a network is out of range of the network, a signal cannot be transmitted to said another electronic device 10. Thus, a going-out scenario may be executed based on an input before the mobile terminal 100 is out of range of the network. Once the mobile terminal 100 transmits a signal related to an interworking application (e.g., a control application), the television 10, the indoor lamp 20 and the air conditioner 30 having received the signal may be switched off to be stopped, according to an execution stop command.

As aforementioned, in the present invention, under an assumption that the electronic device 100 is reciprocally authenticated with said other electronic devices 10, 20, 30, 40, 50, 60, 70, an interworking operation may be executed without a subsequent authentication. Especially, the mobile terminal 100 may be interworked with not only one of said other electronic devices 10, 20, 30, 40, 50, 60, 70, but also all of said other electronic devices 10, 20, 30, 40, 50, 60, 70.

Scenarios based on an interworking operation may include any operations using said other electronic devices 10, 20, 30, 40, 50, 60, 70 included in the home group, such as preparing for shower, washing and cleaning, as shown. However, the scenarios may be variously applied and extended according to the electronic device 100 and said other electronic devices 10, 20, 30, 40, 50, 60, 70.

Hereinafter, a process of adding the new authentication connection electronic device 100 aforementioned with reference to FIG. 8, and a process of determining a new application executable by interworking will be explained.

FIGS. 13A and 13B are conceptual views illustrating that a new authentication connection electronic device 100 is added to the conventional authentication connection electronic devices.

Referring to FIG. 13A, mobile phones 100, 200 are wirelessly connected to each other to thus be reciprocally authenticated with each other, and a robot cleaner 10 and a television 20 are wirelessly connected to the mobile phones 100, 200 to thus be reciprocally authenticated with the mobile phones 100, 200.

Applications executable by interworking are determined based on a preset criterion according to characteristics of the electronic devices, e.g., based on a type and the number of the electronic devices. In case of the mobile phones 100, 200, the applications executable by interworking may be a chatting application and an SMS application. In case of the mobile phone 100 and the robot cleaner 10, the applications executable by interworking may be a control application. And in case of the mobile phone 200 and the television 20, the application executable by interworking may be a screen sharing application.

If another mobile terminal 210 and other electronic devices 10b, 20b, 30a, 30b are newly authenticated as shown in FIG. 13B, applications executable by interworking are newly determined according to a type and the number of said other electronic devices 10b, 20b, 30a, 30b.

For instance, as shown, as said another mobile terminal 210 is newly authenticated, a band application to output music from the mobile phones 100, 200, 210 by using different musical instruments and to form a virtual band may be added to the conventional SMS and chatting applications executable by interworking.

As the robot cleaner 10b is added, an application to control the robot cleaners 10a, 10b to divide a cleaning region may be newly added as an application executable by interworking. In case of adding a plurality of speakers 30a, 30b, an application related to a surround speaker may be newly added as an application executable by interworking. Likewise, in case of adding the television 20b, a chatting application between televisions in a dual mode may be newly added as an application executable by interworking.

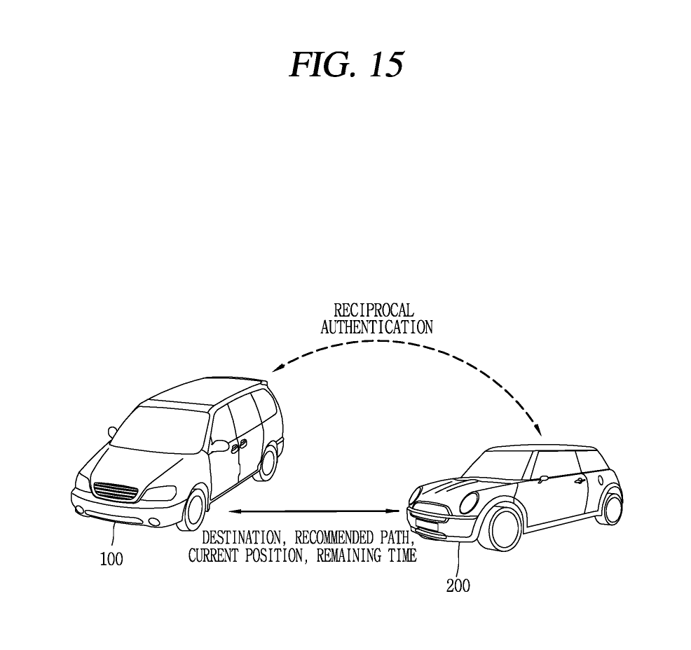

FIGS. 14 and 15 are conceptual views illustrating a plurality of electronic devices which consist of an electronic device system are operated by interworking.

Referring to FIG. 14, electronic devices 100, 200, 300, 400 disposed in a vehicle include a plurality of mobile terminals 100, 200, 300, and an integrated Audio, Video and Navigation (AVN) 400. And all of the electronic devices 100, 200, 300, 400 are reciprocally authenticated with each other. Each of the electronic devices 100, 200, 300, 400 shares files such as images and videos with other electronic devices under an assumption that the electronic devices 100, 200, 300, 400 are connected to each other in a reciprocally-authenticated state. The vehicle is a single electronic device system, and the electronic devices 100, 200, 300, 400 disposed in the vehicle constitute the electronic device system.

For your convenience, the mobile terminals 100, 200, 300 are referred to as first to third electronic devices 100, 200, 300, and descriptions will be explained based on the first electronic device 100. The first electronic device 100 shares photos with the second electronic device 200, and shares a music list with the third electronic device 300.

In this case, the first electronic device 100 may play music stored in the third electronic device 300 not therein, in the AVN 400 of the vehicle. Such an interworking operation is executed through a reciprocally-authenticated connection in the electronic device system, the vehicle.

Likewise, the first electronic device 100 may output image files stored in the second electronic device 200 not therein, to the AVN 400 of the vehicle.

Since the respective electronic devices 100, 200, 300 and the AVN 400 are connected to each other in a reciprocally authenticated state, a Global Positioning System (GPS) of the AVN 400 may be operated by using the electronic devices 100, 200, 300. Accordingly, a person rather than a driver may input a destination by using one of the electronic devices 100, 200, 300, search for a driving path, and provide a search result to the driver.

Referring to FIG. 15, vehicles 100, 200 are electronic devices, and the plurality of vehicles 100, 200 constitute an electronic device system. Once the vehicle 100 of the electronic device system is wirelessly connected to the vehicle 200 to thus be reciprocally authenticated, the two vehicles 100, 200 may share driving information with each other. The vehicles 100, 200 may share destination information, recommended path information, current position information, driving information, etc. If the vehicles 100, 200 have the same destination, convenience in group movement may be provided.

The aforementioned electronic device and electronic device system are not limited to the aforementioned embodiments. The embodiments may be selectively combined with each other partially or wholly, for various modifications.

### INDUSTRIAL APPLICABILITY

The present invention provides an electronic device operated by interworking with another electronic device based on a reciprocally-authenticated connection, and an electronic device system. The present invention may be variously utilized in related industrial fields.

1. An electronic device, comprising:
a wired/wireless communication unit; and
a controller configured to execute an interworking function with another electronic device by cooperating with the wired/wireless communication unit,
wherein the wired/wireless communication unit and the controller perform the steps of:
authenticating with said another electronic device by being connected to said another electronic device by wire or wirelessly, such that the authentication with said another electronic device is completed, before the interworking function with said another electronic device is executed;
determining, based on a preset criterion, an application executable by interworking with said another electronic device through wired/wireless connection; and
transmitting, to said another electronic device, a signal generated from the determined application such that an application corresponding to the determined application is executed in said another electronic device when the determined application is executed, for interworking.

2. The electronic device of claim 1, wherein the signal generated from the determined application includes an execution command with respect to the corresponding application, such that the corresponding application is executed in said another electronic device.

3. The electronic device of claim 1, wherein if the corresponding application has not been installed in said another electronic device, the wired/wireless communication unit and the controller transmit, to said another electronic device, recommendation information with respect to the corresponding application, such that the corresponding application is installed at said another electronic device.

4. The electronic device of claim 3, wherein the recommendation information with respect to the corresponding application includes an on-line address of an external server, such that said another electronic device downloads the corresponding application from the external server, based on the recommendation information.

5. The electronic device of claim 1, wherein the determined application and the corresponding application are determined based on at least one of a type and the number of the electronic device, a communication method with said another electronic device, a hardware and a software supported by said another electronic device, and a reciprocal authentication level with said another electronic device.

6. The electronic device of claim 1, wherein said another electronic device includes a plurality of other electronic devices, and
wherein if other electronic devices rather than said already-authenticated another electronic device are additionally authenticated, the wired/wireless communication unit and the controller perform the steps of:
newly determining, based on a preset criterion, an application executable by interworking with at least part of the plurality of other electronic devices; and
transmitting a signal related to the newly-determined application to at least one of the plurality of other electronic devices when the newly-determined application is executed.

7. The electronic device of claim 6, wherein the wired/wireless communication unit and the controller transmit a signal generated from an application executable by interworking with one of the plurality of electronic devices, to another of them, for interworking among said other electronic devices.

8. The electronic device of claim 1, wherein said other electronic devices include a first electronic device and a second electronic device connected to the electronic device by wire or wirelessly, through a first network and a second network, respectively, and
wherein the wired/wireless communication unit and the controller transmit, to the second electronic device through the second network, a signal received from the first electronic device through the first network, such that the first and second another electronic devices are interworked with each other.

9. An electronic device, comprising:
a wired/wireless communication unit configured to execute wired/wireless communication with another electronic device; and
a controller configured to complete authentication with said another electronic device before an interworking function with said another electronic device is executed, and configured to execute an application corresponding to an application of said another electronic device when the wired/wireless communication unit receives an application-related signal from said another electronic device, for interworking with said another electronic device.

10. The electronic device of claim 9, wherein if the corresponding application has not been installed, the controller controls the wired/wireless communication unit to download the corresponding application from an external server, based on recommendation information provided from said another electronic device.

11. An electronic device system having first and second electronic devices connected to each other by wire or wirelessly,
wherein the first electronic device includes a wired/wireless communication unit, and a controller configured to execute an interworking function with another electronic device by cooperating with the wired/wireless communication unit,
wherein the wired/wireless communication and the controller perform the steps of:
authenticating with the second electronic device by being connected to the second electronic device by wire or wirelessly, such that the authentication with the second electronic device is completed before an interworking function with the second electronic device is executed;
determining, based on a preset criterion, an application executable by interworking with the second electronic device through wired/wireless connection; and
transmitting, to the second electronic device, a signal generated from the determined application such that an application corresponding to the determined application is executed in the second electronic device when the determined application is executed, for interworking, and
wherein if information about the determined application is transmitted to the second electronic device from the first electronic device, the second electronic device executes an application corresponding to the determined application such that an operation interworked with the first electronic device is executable.

12. The electronic device system of claim 11, wherein if the corresponding application has not been installed in the second electronic device, the wired/wireless communication unit and the controller of the first electronic device transmit, to the second electronic device, recommendation information with respect to the corresponding application, such that the corresponding application is installed at the second electronic device.

13. The electronic device system of claim 12, wherein the recommendation information with respect to the corresponding application includes an on-line address of an external server, such that the second electronic device downloads the corresponding application from the external server, based on the recommendation information.

14. The electronic device system of claim 11, wherein the determined application and the corresponding application are determined based on at least one of a type and the number of the first and second electronic devices, a communication method between the first and second electronic devices, a hardware and a software supported by the first and second electronic devices, and a reciprocal authentication level between the first and second electronic devices.

15. The electronic device system of claim 11, further comprising a third electronic device connected to the first electronic device by wire or wirelessly,
wherein the wired/wireless communication unit and the controller perform the steps of:
authenticating with the third electronic device by being connected to the third electronic device by wire or wirelessly, such that the authentication with the third electronic device is completed before an interworking function with the third electronic device is executed;
determining, based on a preset criterion, an application executable by interworking with the third electronic device through wired/wireless connection;
transmitting, to the third electronic device, a signal generated from the determined application such that an application corresponding to the determined application is executed in the third electronic device when the determined application is executed, for interworking; and
transmitting a signal generated from an application executable by interworking with one of the second and third electronic devices, to another of them, for interworking between the second and third electronic devices.
